(19) United States
(12) Patent Application Publication
(10) Pub. No.: US 2023/0401488 A1
(43) Pub. Date: Dec. 14, 2023

(54) MACHINE LEARNING METHOD, INFORMATION PROCESSING SYSTEM, INFORMATION PROCESSING APPARATUS, SERVER, AND PROGRAM

(71) Applicant: FUJIFILM Corporation, Tokyo (JP)

(72) Inventors: Masahiro SATO, Tokyo (JP); Tomoki TANIGUCHI, Tokyo (JP); Tomoko OHKUMA, Tokyo (JP)

(73) Assignee: FUJIFILM Corporation, Tokyo (JP)

(21) Appl. No.: 18/333,554

(22) Filed: Jun. 13, 2023

(30) Foreign Application Priority Data
Jun. 14, 2022 (JP) 2022-095950

(51) Int. Cl. G06N 20/00

(52) U.S. Cl. CPC G06N 20/00

(57) ABSTRACT

An information processing system includes one or more processors, in which the one or more processors are configured to: perform a training, by using data of each facility collected at each of a plurality of facilities, of a local model that predicts, for each of the facilities, a behavior of a user on an item; perform an evaluation of a difference between models in a parameter of the local model trained for each of the facilities; and correct the training of the local model such that the difference between the models is small based on a result of the evaluation.

### CROSS-REFERENCE TO RELATED APPLICATION

The present application claims priority under 35 U.S.C § 119(a) to Japanese Patent Application No. 2022-095950 filed on Jun. 14, 2022, which is hereby expressly incorporated by reference, in its entirety, into the present application.

### BACKGROUND OF THE INVENTION

### 1. Field of the Invention

The present disclosure relates to a machine learning method, an information processing system, an information processing apparatus, a server, and a program, and more particularly to an information suggestion technique and a machine learning technique for making a robust suggestion for a domain shift.

### 2. Description of the Related Art

In a system that provides various items to a user, such as an electronic commerce (EC) site or a document information management system, it is difficult for the user to select the best item that suits the user from among many items in terms of time and cognitive ability. The item in the EC site is a product handled in the EC site, and the item in the document information management system is document information stored in the system.

In order to assist the user in selecting an item, an information suggestion technique, which is a technique of presenting a selection candidate from a large number of items, has been studied. In general, in a case where a suggestion system is introduced into a certain facility or the like, a model of the suggestion system is trained based on data collected at the introduction destination facility or the like. However, in a case where the same suggestion system is introduced in a facility different from the facility where the data used for the training is collected, there is a problem that the prediction accuracy of the model is decreased. The problem that a machine learning model does not work well at unknown other facilities is called domain shift, and research related to domain generalization, which is research on improving robustness against the domain shift, has been active in recent years, mainly in the field of image recognition. However, there have been few research cases on domain generalization in the information suggestion technique.

In the field of machine learning, it is often not possible to take data out of the facility for reasons such as the confidentiality of the data used for a training. In such a case, research is being conducted on a technique of federated learning in which a model is trained only by transferring data such as parameters of an artificial intelligence (AI) model while keeping the data in each facility. Research on federated learning is also being conducted in the field of an information suggestion. For example, an algorithm that trains a global model and then trains a local model is proposed in A. Jalalirad, Marco Scavuzzo, Catalin Capota, Michael R. Sprague, “A Simple and Efficient Federated Recommender System” (BDCAT 2019).

Further, JP2019-526851A discloses a configuration in which proxy data, which is pseudo data, is generated at each facility, and the data is shared with a global server instead of local private data in a case where there is a restriction on data that can be used from a private perspective, such as the patient data of the hospital. According to the technology disclosed in JP2021-121922A, a global model can be trained by using proxy data without sharing real data (private data) having high confidentiality.

JP2021-121922A discloses a configuration in which a feature amount is selected by using data of a plurality of facilities. The technology disclosed in JP2021-121922A assumes a suggestion system, and uses a feature amount importance degree of a tree model such as an eXtreme Gradient Boosting (XGBoost) based on user sample data that is common between facilities.

### SUMMARY OF THE INVENTION

Both of the methods described in A. Jalalirad, Marco Scavuzzo, Catalin Capota, Michael R. Sprague, “A Simple and Efficient Federated Recommender System” (BDCAT 2019) and JP2019-526851A and JP2021-121922A are all aimed at improving prediction performance of a model at a facility (trained facilities) where the data used for a training is collected, and the performance of a model for unknown facilities that have not been trained cannot be ensured. Quande Liu, Cheng Chen, Jing Qin, Qi Dou, Pheng-Ann Heng, “FedDG: Federated Domain Generalization on Medical Image Segmentation via Episodic Learning in Continuous Frequency Space” (CVPR 2021) discloses a problem that robustness with respect to another unknown domain cannot be ensured, that is, a problem that the performance of a model is decreased in the unknown domain, in a federated learning method in the related art.

Quande Liu, Cheng Chen, Jing Qin, Qi Dou, Pheng-Ann Heng, “FedDG: Federated Domain Generalization on Medical Image Segmentation via Episodic Learning in Continuous Frequency Space” (CVPR 2021) has a content related to a domain generalization of a model for performing medical image segmentation, and in order to solve the above-mentioned problem of federated learning, an image signal is converted into a frequency space and further is decomposed into an amplitude and a phase. It is assumed that the amplitude corresponds to low-order information such as an image style, and the phase corresponds to higher-order information related to the meaning of the image, and by performing a training while replacing the amplitude distribution between local models, the federated learning, which is robust on the domain shift, is realized.

However, the method disclosed in Quande Liu, Cheng Chen, Jing Qin, Qi Dou, Pheng-Ann Heng, “FedDG: Federated Domain Generalization on Medical Image Segmentation via Episodic Learning in Continuous Frequency Space” (CVPR 2021) is based on assumptions specific to image data and cannot be applied to the information suggestion technique.

The present disclosure has been made in view of such circumstances, and it is an object of the present disclosure to provide a machine learning method, an information processing system, an information processing apparatus, a server, and a program capable of generating a model having high performance for unknown facilities even in a case where data of a plurality of facilities cannot be shared outside the facility in the case of training a prediction model used for an information suggestion.

A machine learning method according to a first aspect of the present disclosure executed by an information processing system including one or more processors, the machine learning method comprises: causing the information processing system to execute: performing a training, by using data of each facility collected at each of a plurality of facilities, of a local model that predicts, for each of the facilities, a behavior of a user on an item; performing an evaluation of a difference between models in a parameter of the local model trained for each of the facilities; and correcting the training of the local model such that the difference between the models is small based on a result of the evaluation.

According to the first aspect, it is possible to perform the training of the local model for a facility unit by using the respective data for each facility without aggregating the data of the plurality of facilities. By transferring the parameters of the local model trained in each facility, the information of the local models of the plurality of facilities is aggregated, and the difference between the models in the parameter of each local model is evaluated. Thereafter, the training for each local model is corrected such that the difference between the models is small. By repeating such processes, the difference between the models of each local model gradually decreases. By repeating the training and the correction of each local model until the difference between the models becomes small to an acceptable level, a universal relationship that does not depend on the facility is trained, and a model having a robust performance against the differences in the facilities is obtained. The machine learning method according to the first aspect can be understood as a method (manufacturing method) of producing a model applied to the information suggestion.

The model includes the concept of a program that enables the processor to realize the function of prediction. The information processing system may be, for example, a computer system including a plurality of computers. The machine learning method according to the first aspect may be performed by distributed computing. The facility includes the concept of a group including a plurality of users, for example, a company, a hospital, a store, a government agency, or an EC site. Each of the plurality of facilities can be in a different domain from each other.

The “correction” in the case of “correcting the training of the local model” includes the meaning of making a change to the trained local model. The “change” includes the concept of the “correction”. The correction may be to change the parameter of the local model, may be to select the feature amount in the local model, or may be a combination of these.

In the machine learning method of a second aspect of the present disclosure according to the machine learning method of the first aspect, the correcting of the training of the local model may include changing the parameter such that the difference between the models is small.

In the machine learning method of a third aspect of the present disclosure according to the machine learning method of the second aspect, the local model may include a cross feature amount, and the machine learning method may further execute causing the information processing system to include changing the parameter such that the difference between the models in the parameter, which is a weight of the cross feature amount, is small in the case of correcting the training of the local model.

In the machine learning method of a fourth aspect of the present disclosure according to the machine learning method of any one of the first to third aspects, the correcting of the training of the local model may include changing the local model by, from among a plurality of feature amounts included in the local model, selecting a feature amount, in which the difference between the models in the parameter is relatively small and by deleting a feature amount, in which the difference between the models in the parameter is relatively large, from the local model.

The information processing system may, for example, delete, from the local model, a feature amount, in which the difference between the models in the parameter is greater than a reference value, or may delete, from the local model, a feature amount, in which the difference between the models in the parameter is the largest or some of the top feature amounts in descending order of difference.

In the machine learning method of a fifth aspect of the present disclosure according to the machine learning method of the fourth aspect, the local model may include a cross feature amount, and the machine learning method may further include causing the information processing system to execute: from among the plurality of feature amounts including the cross feature amount, selecting a cross feature amount, in which the difference between the models in the parameter that is a weight of the cross feature amount is relatively small; and deleting a cross feature amount, in which the difference between the models in the parameter is relatively large, in the case of correcting the training of the local model. The cross feature amount is a form of the feature amount.

In the machine learning method of a sixth aspect of the present disclosure according to the machine learning method of the third or fifth aspect, the weight of the cross feature amount may be represented in a relation between embedding representations of each of the feature amounts.

In the machine learning method of a seventh aspect of the present disclosure according to the machine learning method of the sixth aspect, the relation between the embedding representations of each of the feature amounts may be an inner product of vectors indicating each of the feature amounts.

In the machine learning method of an eighth aspect of the present disclosure according to the machine learning method of any one of the first to seventh aspects, the local model may be a model that performs a neighborhood-based collaborative filtering, which is based on at least one of relationships between users or between items, and the parameter of the local model may include a correlation coefficient that indicates at least one of the relationships between the users or between the items.

The machine learning method of a ninth aspect of the present disclosure according to the machine learning method of the eighth aspect may further include causing the information processing system to execute changing the correlation coefficient such that a difference in the correlation coefficient between the models is made to be small in the case of correcting the training of the local model.

The machine learning method of a tenth aspect of the present disclosure according to the machine learning method of the eighth or ninth aspect, may further include causing the information processing system to execute: from among a plurality of the relationships included in the local model, selecting a relationship, in which a difference in the correlation coefficient between the models is relatively small; and deleting a relationship, in which the difference in the correlation coefficient between models is relatively large, from the local model, in the case of correcting the training of the local model.

In the machine learning method of an eleventh aspect of the present disclosure according to the machine learning method of any one of the first to tenth aspects, the information processing system may include a plurality of information processing apparatuses, which execute the training of the local model, corresponding to each of the plurality of facilities, and a server that is connected to each of the plurality of information processing apparatuses via an electric communication line in a communicable manner, and the training may be performed by using federated learning for communicating at least one of the parameter of the local model or an update amount of the parameter between the information processing apparatus and the server without communicating the data of each facility.

In the machine learning method of a twelfth aspect of the present disclosure according to the machine learning method of the eleventh aspect, the server may acquire the parameter of the local model from each of the plurality of information processing apparatuses, perform an evaluation of the difference between the models in the parameter of the local model, and perform an instruction of correcting the training with respect to each of the plurality of information processing apparatuses, and each of the plurality of information processing apparatuses may perform at least one of changing the parameter of the local model or selecting a feature amount, based on the instruction.

In the machine learning method of a thirteenth aspect of the present disclosure according to the machine learning method of the eleventh or twelfth aspect, the local model may be a model that performs a neighborhood-based collaborative filtering, which is based on at least one of relationships between users or between items, and the parameter of the local model may include a correlation coefficient that indicates at least one of the relationships between the users or between the items.

An information processing system according to a fourteenth aspect of the present disclosure is an information processing system comprising: one or more processors, in which the one or more processors are configured to: perform a training, by using data of each facility collected at each of a plurality of facilities, of a local model that predicts, for each of the facilities, a behavior of a user on an item; perform an evaluation of a difference between models in a parameter of the local model trained for each of the facilities; and correct the training of the local model such that the difference between the models is small based on a result of the evaluation.

The information processing system according to the fourteenth aspect can be understood as a machine learning system for generating a prediction model applied to the information suggestion. The information processing system may be a centralized system or a distributed system.

The information processing system according to the fourteenth aspect can include the same specific aspect as the information processing method according to any one of the second to thirteenth aspects described above.

The information processing system of a fifteenth aspect of the present disclosure according to the information processing system of the fourteenth aspect may further include: a plurality of information processing apparatuses, which execute the training of the local model, corresponding to each of the plurality of facilities; and a server that is connected to each of the plurality of information processing apparatuses via an electric communication line in a communicable manner, in which the training may be performed by using federated learning for communicating at least one of the parameter of the local model or an update amount of the parameter between the plurality of information processing apparatuses and the server without communicating the data of each facility.

An information processing apparatus according to a sixteenth aspect of the present disclosure comprises: one or more first processors; and one or more first storage devices, in which the one or more first processors are configured to: perform a training, by using first data collected at a first facility, of a first local model that predicts a behavior of a user on an item in the first facility; transmit a parameter of the first local model, on which the training is performed, to a server; receive, from the server, an instruction of correcting the training of the first local model such that a difference between models in a parameter of a second local model trained by using second data that is collected at a second facility different from the first facility, is smaller; and update the first local model based on the received instruction.

The information processing apparatus according to the sixteenth aspect may be disposed for each of the plurality of first facilities that are different from each other. The information processing apparatus can function as a learning apparatus that performs a training of the first local model in cooperation with the server.

The information processing apparatus according to the sixteenth aspect can include the same specific aspect as the information processing method according to any one of the second to thirteenth aspects described above.

A server according to a seventeenth aspect of the present disclosure comprises: one or more second processors; and one or more second storage devices, in which the one or more second processors are configured to: acquire a parameter of a local model trained at each of a plurality of information processing apparatuses corresponding to each of a plurality of facilities; perform an evaluation of a difference between models in the parameter of the local model for each of the facilities; and transmit an instruction of correcting a training of the local model such that the difference between the models is small with respect to each of the plurality of information processing apparatuses, based on a result of the evaluation.

According to the seventeenth aspect, the parameters of each of the local models trained in each of the plurality of information processing apparatuses are aggregated in the server, and the difference between the models in the parameters of the local model for each facility is evaluated in the server. The server controls an operation of the training in each information processing apparatus so as to correct the training of each local model such that the difference between the models is small. The server can play a role of a central server that collectively controls the training of the local model in each of the plurality of information processing apparatuses. The server may generate a global model by aggregating the parameters of the plurality of local models trained in each of the plurality of information processing apparatuses.

The information processing apparatus according to the seventeenth aspect can include the same specific aspect as the information processing method according to any one of the second to thirteenth aspects described above.

A program according to an eighteenth aspect of the present disclosure causes a computer to realize: a function of performing a training, by using data of each facility collected at each of a plurality of facilities, of a local model that predicts, for each of the facilities, a behavior of a user on an item; a function of performing an evaluation of a difference between models in a parameter of the local model trained for each of the facilities; and a function of correcting the training of the local model such that the difference between the models is small based on a result of the evaluation.

The computer in the eighteenth aspect includes the concept of a distributed system. The program according to the eighteenth aspect can include the same specific aspect as the information processing method according to any one of the second to thirteenth aspects described above.

A program according to a nineteenth aspect of the present disclosure causes a computer to realize: a function of performing a training, by using first data collected at a first facility, of a first local model that predicts a behavior of a user on an item in the first facility; a function of transmitting a parameter of the first local model, on which the training is performed, to a server; a function of receiving, from the server, an instruction of correcting the training of the first local model such that a difference between models in a parameter of a second local model trained by using second data that is collected at a second facility different from the first facility, is smaller; and a function of updating the first local model based on the received instruction.

The program according to the nineteenth aspect can include the same specific aspect as the information processing method according to any one of the second to thirteenth aspects described above.

A program according to a twentieth aspect of the present disclosure causes a computer to realize: a function of acquiring a parameter of a local model trained at each of a plurality of information processing apparatuses corresponding to each of a plurality of facilities; a function of performing an evaluation of a difference between models in the parameter of the local model for each of the facilities; and a function of transmitting an instruction of correcting a training of the local model such that the difference between the models is small with respect to each of the plurality of information processing apparatuses, based on a result of the evaluation.

The program according to the twentieth aspect can include the same specific aspect as the information processing method according to any one of the second to thirteenth aspects described above.

According to the present disclosure, since the difference between the models in the parameter of the local model trained for each facility is evaluated and the training of each local model is corrected such that the difference between the models is small, it becomes possible to generate a model having robust performance against the differences in facilities even in a case where data of the plurality of facilities cannot be shared outside the facility. As a result, it is possible to obtain a model having high performance even for an unknown other facility different from the facility where the data used for a training is collected.

### BRIEF DESCRIPTION OF THE DRAWINGS

FIG. 1 is a conceptual diagram of a typical suggestion system.

FIG. 2 is a conceptual diagram showing an example of machine learning with a teacher that is widely used in building a suggestion system.

FIG. 3 is an explanatory diagram showing a typical introduction flow of the suggestion system.

FIG. 4 is an explanatory diagram of an introduction flow of the suggestion system in a case where data of an introduction destination facility cannot be obtained.

FIG. 5 is an explanatory diagram in a case where a model is trained by domain adaptation.

FIG. 6 is an explanatory diagram of an introduction flow of the suggestion system including a step of evaluating the performance of the trained model.

FIG. 7 is an explanatory diagram showing an example of training data and evaluation data used for the machine learning.

FIG. 8 is a graph schematically showing a difference in performance of a model due to a difference in a dataset.

FIG. 9 is a conceptual diagram of general federated learning.

FIG. 10 is a conceptual diagram of a mechanism for training a global model and then training a local model in federated learning.

FIG. 11 is an explanatory diagram showing an outline of a machine learning method according to an embodiment of the present disclosure.

FIG. 12 is a block diagram showing an example of an overall configuration of a machine learning system according to the embodiment.

FIG. 13 is a block diagram showing an example of a hardware configuration of an information processing apparatus that functions as a local learning apparatus.

FIG. 14 is a block diagram showing an example of a hardware configuration of a global server.

FIG. 15 is an explanatory diagram showing an outline of a first example of the machine learning method performed by the machine learning system according to the embodiment.

FIG. 16 is a flowchart showing the first example of the machine learning method according to the embodiment.

FIG. 17 is a functional block diagram showing Example 1 of a functional configuration of the information processing apparatus that functions as the local learning apparatus.

FIG. 18 is a functional block diagram showing Example 1 of a functional configuration of the global server.

FIG. 19 is an explanatory diagram illustrating an outline of a second example of the machine learning method performed by the machine learning system.

FIG. 20 is an explanatory diagram showing an example of vector representations of each of a user attribute and an item attribute in a domain d1.

FIG. 21 is a functional block diagram showing Example 2 of a functional configuration of the information processing apparatus that functions as the local learning apparatus.

FIG. 22 is a functional block diagram showing Example 2 of a functional configuration of the global server.

FIG. 23 is a chart showing an example of behavior history data of a user on an item in a certain company 1.

### DESCRIPTION OF THE PREFERRED EMBODIMENTS

Hereinafter, preferred embodiments of the present invention will be described with reference to the accompanying drawings.

Overview of Information Suggestion Technique

First, the outline and problems of an information suggestion technique will be overviewed by showing specific examples. The information suggestion technique is a technique for suggesting an item to a user.

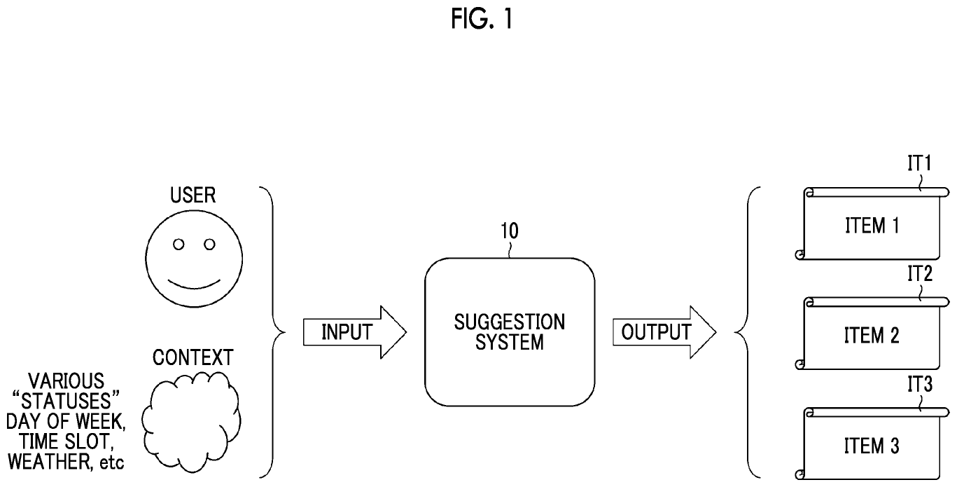

FIG. 1 is a conceptual diagram of a typical suggestion system 10. The suggestion system 10 receives user information and context information as inputs and outputs information of the item that is suggested to the user according to a context. The context means various “statuses” and may be, for example, a day of the week, a time slot, or the weather. The items may be various objects such as a book, a video, a restaurant, and the like.

The suggestion system 10 generally suggests a plurality of items at the same time. FIG. 1 shows an example in which the suggestion system 10 suggests three items of IT1, IT2, and IT3.

In a case where the user responds positively to the suggested items IT1, IT2, and IT3, the suggestion is generally considered to be successful. A positive response is, for example, a purchase, browsing, or visit. Such a suggestion technique is widely used, for example, in an EC site, a gourmet site that introduces a restaurant, or the like.

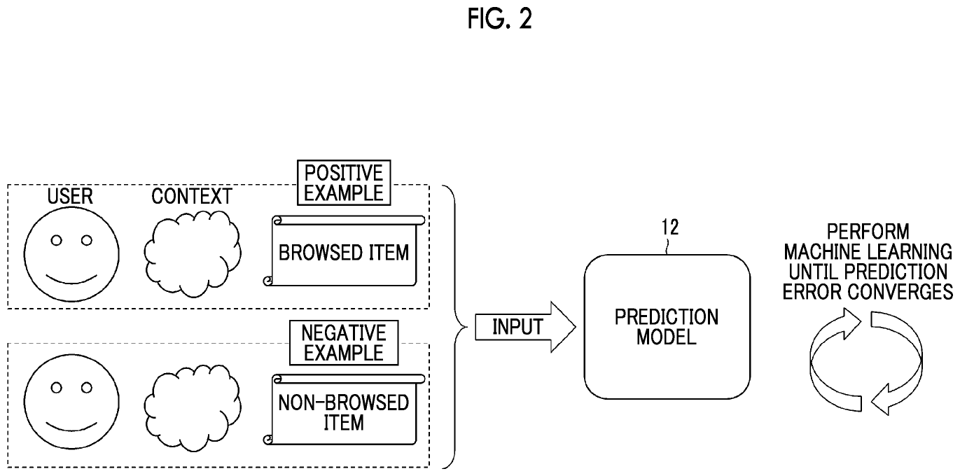

The suggestion system 10 is built by using a machine learning technique. FIG. 2 is a conceptual diagram showing an example of machine learning with a teacher that is widely used in building the suggestion system 10. Generally, a positive example and a negative example are prepared based on a user behavior history in the past, a combination of the user and the context is input to a prediction model 12, and the prediction model 12 is trained such that a prediction error becomes small. For example, a browsed item that is browsed by the user is defined as a positive example, and a non-browsed item that is not browsed by the user is defined as a negative example. The machine learning is performed until the prediction error converges, and the target prediction performance is acquired.

By using the trained prediction model 12, which is trained in this way, items with a high browsing probability, which is predicted with respect to the combination of the user and the context, are suggested. For example, in a case where a combination of a certain user A and a context R is input to the trained prediction model 12, the prediction model 12 infers that the user A has a high probability of browsing a document such as the item IT3 under a condition of the context R and suggests an item similar to the item IT3 to the user A. Depending on the configuration of the suggestion system 10, items are often suggested to the user without considering the context.

Example of Data Used for Developing Suggestion System

The user behavior history is substantially equivalent to “correct answer data” in machine learning. Strictly speaking, it is understood as a task setting of inferring the next (unknown) behavior from the past behavior history, but it is general to train the potential feature amount based on the past behavior history.

The user behavior history may include, for example, a book purchase history, a video browsing history, or a restaurant visit history.

Further, main feature amounts include a user attribute and an item attribute. The user attribute may have various elements such as, for example, gender, age group, occupation, family structure, and residential area. The item attribute may have various elements such as a book genre, a price, a video genre, a length, a restaurant genre, and a place.

Model Building and Operation

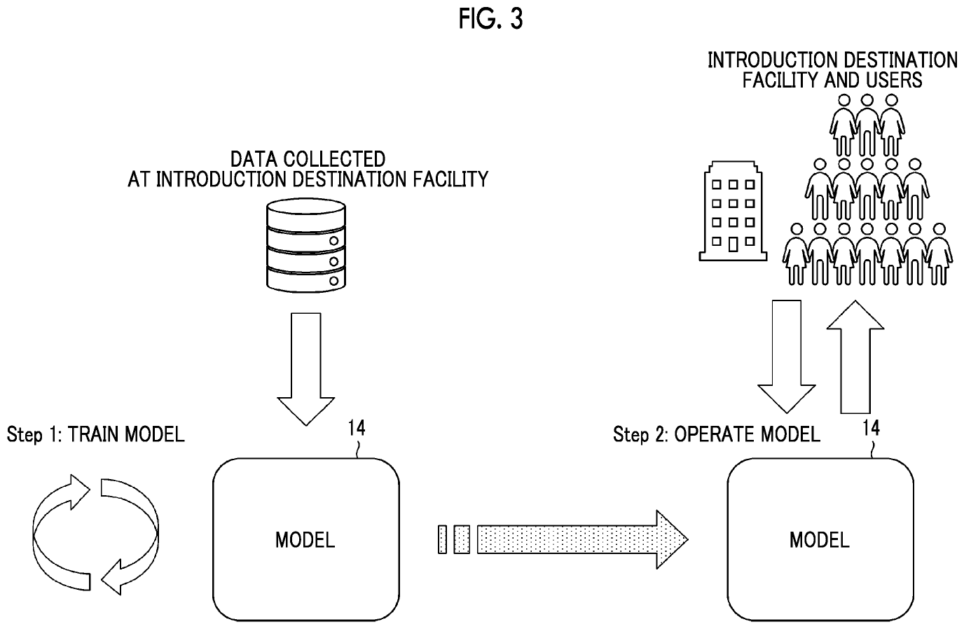

FIG. 3 is an explanatory diagram showing a typical introduction flow of the suggestion system. Here, a typical flow in a case where the suggestion system is introduced to a certain facility, is shown. To introduce the suggestion system, first, a model 14 for performing a target suggestion task is built (Step 1), and then the built model 14 is introduced and operated (Step 2). In the case of a machine learning model, “Building” the model 14 includes training the model 14 by using training data to create a prediction model (suggestion model) that satisfies a practical level of suggestion performance. “Operating” the model 14 is, for example, obtaining an output of a suggested item list from the trained model 14 with respect to the input of the combination of the user and the context.

Data for a training is required for building the model 14. As shown in FIG. 3, in general, the model 14 of the suggestion system is trained based on the data collected at an introduction destination facility. By performing training by using the data collected from the introduction destination facility, the model 14 learns the behavior of the user in the introduction destination facility and can accurately predict suggestion items for the user in the introduction destination facility.

However, due to various circumstances, it may not be possible to obtain data on the introduction destination facility. For example, in the case of a document information suggestion system in an in-house system of a company or an in-hospital system of a hospital, a company that develops a suggestion model often cannot access the data of the introduction destination facility. In a case where the data of the introduction destination facility cannot be obtained, instead, it is necessary to perform training based on data collected at different facilities.

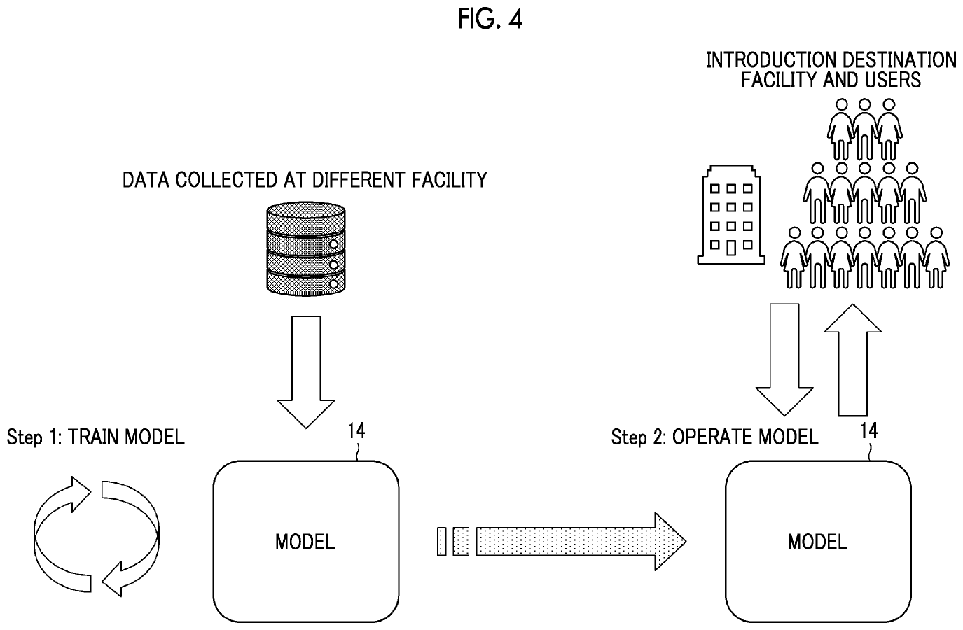

FIG. 4 is an explanatory diagram of an introduction flow of the suggestion system in a case where data of an introduction destination facility cannot be obtained. In a case where the model 14, which is trained by using the data collected in a facility different from the introduction destination facility, is operated in the introduction destination facility, there is a problem that the prediction accuracy of the model 14 decreases due to differences in user behavior between facilities.

The problem that the machine learning model does not work well in unknown facilities different from the trained facility is understood as a technical problem, in a broad sense, to improve robustness against a problem of domain shift in which a source domain where the model 14 is trained differs from a target domain where the model 14 is applied. Domain adaptation is a problem setting related to domain generalization. This is a method of training by using data from both the source domain and the target domain. The purpose of using the data of different domains in spite of the presence of the data of the target domain is to make up for the fact that the amount of data of the target domain is small and insufficient for a training.

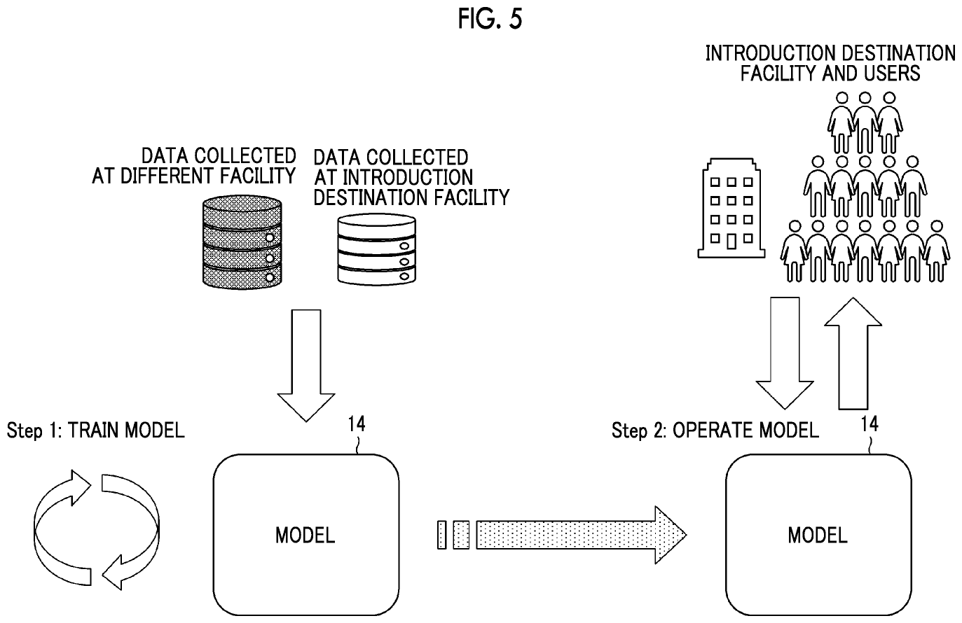

FIG. 5 is an explanatory diagram in a case where the model 14 is trained by domain adaptation. Although the amount of data collected at the introduction destination facility that is the target domain is relatively smaller than the data collected at a different facility, the model 14 can also predict with a certain degree of accuracy the behavior of the users in the introduction destination facility by performing a training by using both data.

Description of Domain

The above-mentioned difference in a “facility” is a kind of difference in a domain. In Ivan Cantador et al, Chapter 27: “Cross-domain Recommender System”, which is a document related to research on domain adaptation in information suggestion, differences in domains are classified into the following four categories.

[1] Item attribute level: For example, a comedy movie and a horror movie are in different domains.

[2] Item type level: For example, a movie and a TV drama series are in different domains. [3] Item level: For example, a movie and a book are in different domains. [4] System level: For example, a movie in a movie theater and a movie broadcast on television are in different domains.

The difference in “facility” shown in FIG. 5 or the like corresponds to [4] system-level domain in the above four categories.

In a case where a domain is formally defined, the domain is defined by a simultaneous probability distribution P(X, Y) of a response variable Y and an explanatory variable X, and in a case where Pd1(X, Y)≠Pd2(X, Y), d1 and d2 are different domains.

The simultaneous probability distribution P(X, Y) can be represented by a product of an explanatory variable distribution P(X) and a conditional probability distribution P(YIX) or a product of a response variable distribution P(Y) and a conditional probability distribution P(Y|X).

P(X,Y)=P(Y|X)P(X)=P(X|Y)P(Y)

Therefore, in a case where one or more of P(X), P(Y), P(Y|X), and P(X|Y) is changed, the domains become different from each other.

Typical Pattern of Domain Shift

Covariate Shift

A case where distributions P(X) of explanatory variables are different is called a covariate shift. For example, a case where distributions of user attributes are different between datasets, more specifically, a case where a gender ratio is different, and the like correspond to the covariate shift.

Prior Probability Shift

A case where distributions P(Y) of the response variables are different is called a prior probability shift. For example, a case where an average browsing ratio or an average purchase ratio differs between datasets corresponds to the prior probability shift.

Concept Shift

A case where conditional probability distributions P(Y|X) and P(X|Y) are different is called a concept shift. For example, a probability that a research and development department of a certain company reads data analysis materials is assumed as P(Y|X), and in a case where the probability differs between datasets, this case corresponds to the concept shift.

Research on domain adaptation or domain generalization includes assuming one of the above-mentioned patterns as a main factor and looking at dealing with P(X, Y) changing without specifically considering which pattern is a main factor. In the former case, there are many cases in which a covariate shift is assumed.

Reason for Influence of Domain Shift A prediction/classification model that performs a prediction or classification task makes inferences based on a relationship between the explanatory variable X and the response variable, thereby in a case where P(Y|X) is changed, naturally the prediction/classification performance is decreased. Further, although minimization of a prediction/classification error is performed within learning data in a case where machine learning is performed on the prediction/classification model, for example, in a case where the frequency in which the explanatory variable becomes X=X_1 is greater than the frequency in which the explanatory variable becomes X=X_2, that is, in a case where P(X=X_1)>P(X=X_2), the data of X=X_1 is more than the data of X=X_2, thereby error decrease for X=X_1 is trained in preference to error decrease for X=X_2. Therefore, even in a case where P(X) is changed between the facilities, the prediction/classification performance is decreased.

The domain shift can be a problem not only for information suggestion but also for various task models. For example, regarding a model that predicts the retirement risk of an employee, a domain shift may become a problem in a case where a prediction model, which is trained by using data of a certain company, is operated by another company.

Further, in a model that predicts an antibody production amount of a cell, a domain shift may become a problem in a case where a model, which is trained by using data of a certain antibody, is used for another antibody. Further, for a model that classifies the voice of customer (VOC), for example, a model that classifies VOC into “product function”, “support handling”, and “other”, a domain shift may be a problem in a case where a classification model, which is trained by using data related to a certain product, is used for another product.

Regarding Evaluation before Introduction of Model

In many cases, a performance evaluation is performed on the model 14 before the trained model 14 is introduced into an actual facility or the like. The performance evaluation is necessary for determining whether or not to introduce the model and for research and development of models or learning methods.

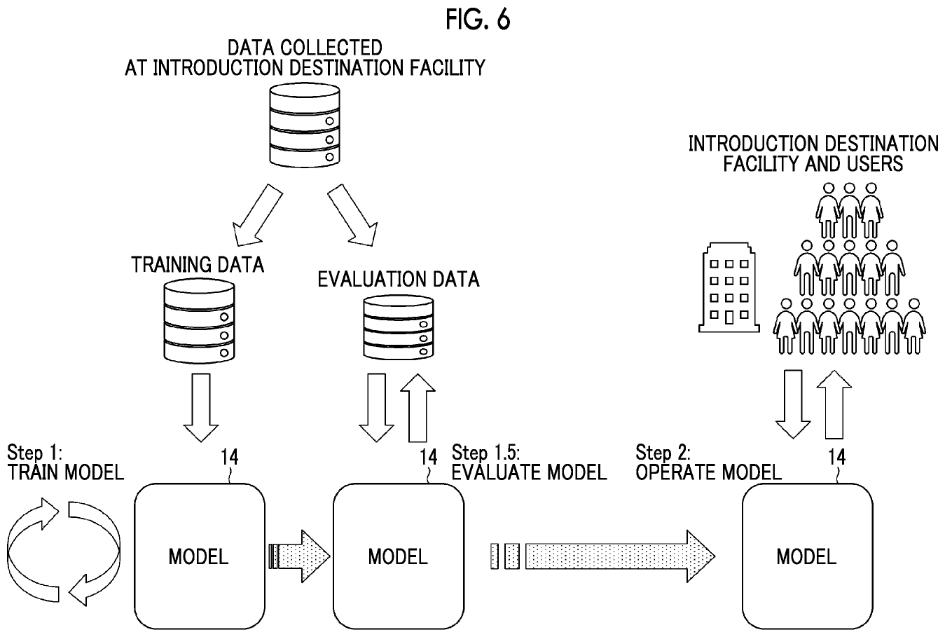

FIG. 6 is an explanatory diagram of an introduction flow of the suggestion system including a step of evaluating the performance of the trained model 14. In FIG. 6, a step of evaluating the performance of the model 14 is added as “step 1.5” between Step 1 (the step of training the model 14) and Step 2 (the step of operating the model 14) described in FIG. 5. Other configurations are the same as in FIG. 5. As shown in FIG. 6, in a general introduction flow of the suggestion system, the data, which is collected at the introduction destination facility, is often divided into training data and evaluation data. The prediction performance of the model 14 is checked by using the evaluation data, and then the operation of the model 14 is started.

However, in a case of building the model 14 of domain generalization, the training data and the evaluation data need to be different domains. Further, in the domain generalization, it is preferable to use the data of a plurality of domains as the training data, and it is more preferable that there are many domains that can be used for a training.

Regarding Generalization

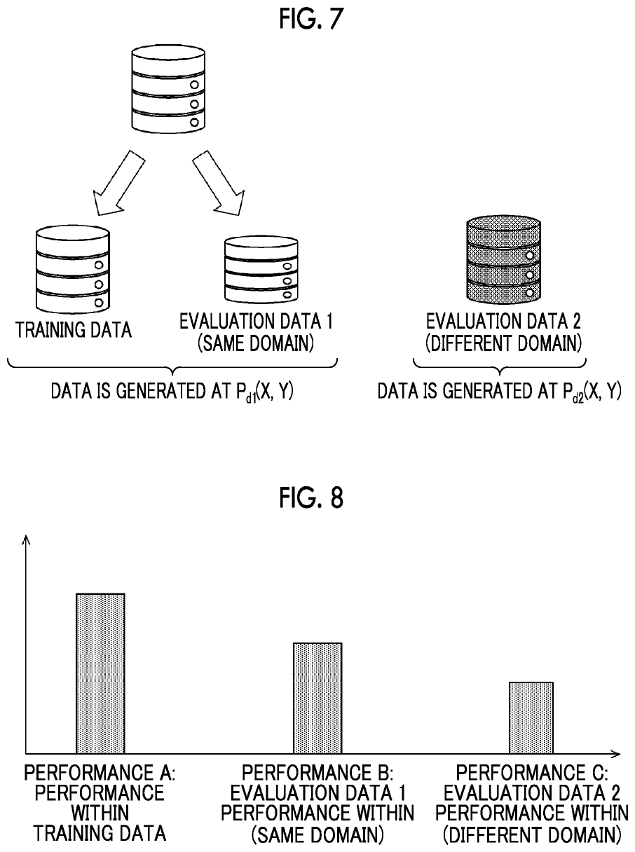

FIG. 7 is an explanatory diagram showing an example of the training data and the evaluation data used for the machine learning. The dataset obtained from the simultaneous probability distribution Pd1(X, Y) of a certain domain d1 is divided into training data and evaluation data. The evaluation data of the same domain as the training data is referred to as “first evaluation data” and is referred to as “evaluation data 1” in FIG. 7. Further, a dataset, which is obtained from a simultaneous probability distribution Pd2(X, Y) of a domain d2 different from the domain d1, is prepared and is used as the evaluation data. The evaluation data of the domain different from the training data is referred to as “second evaluation data” and is referred to as “evaluation data 2” in FIG. 7.

The model 14 is trained by using the training data of the domain d1, and the performance of the model 14, which is trained by using each of the first evaluation data of the domain d1 and the second evaluation data of the domain d2, is evaluated.

FIG. 8 is a graph schematically showing a difference in performance of the model due to a difference in the dataset. Assuming that the performance of the model 14 in the training data is defined as performance A, the performance of the model 14 in the first evaluation data is defined as performance B, and the performance of the model 14 in the second evaluation data is defined as performance C, normally, a relationship is represented such that performance A>performance B>performance C, as shown in FIG. 8.

High generalization performance of the model 14 generally indicates that the performance B is high, or indicates that a difference between the performances A and B is small. That is, the aim is to achieve high prediction performance even for untrained data without over-fitting to the training data.

In the context of domain generalization in the present specification, it means that the performance C is high or a difference between the performance B and the performance C is small. In other words, the aim is to achieve high performance consistently even in a domain different from the domain used for the training.

### Description of Problem

In the present embodiment, in a case of training a model applied to a system that performs an information suggestion, it is assumed a case where data, which is collected at each of a plurality of facilities, cannot be taken out of each facility, and a method of obtaining a model that is robust to a domain shift is provided, which can realize a high performance information suggestion even at unknown facilities that are different from the facility where the data used for a training is collected.

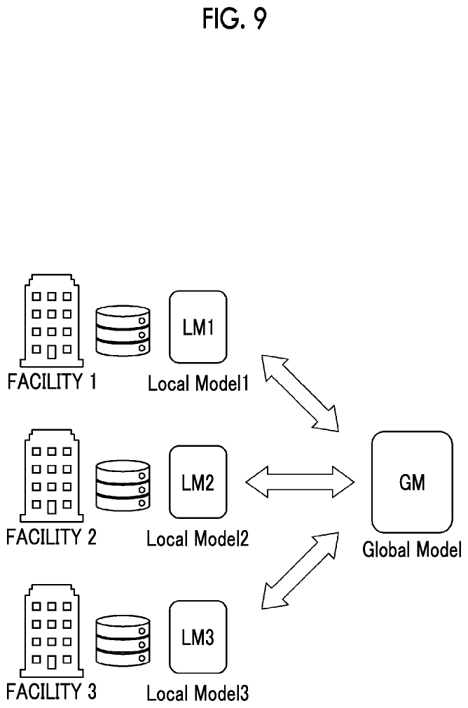

FIG. 9 is a conceptual diagram of general federated learning. Here, as an example of a plurality of facilities, three facilities of a facility 1 to a facility 3, will be shown as an example. The number of facilities may be any number of 2 or more. The type of the facility is not limited, and may be, for example, a company, a hospital, or a store such as a retail store. Hereinafter, the index number k for distinguishing the facilities will be used and will be referred to as “facility k” or the like.

A training of a local model LMk is performed for each facility while keeping data, which is collected at each facility k, in that facility. An information processing apparatus (hereinafter, referred to as a local learning apparatus) that executes a learning process of the local model LMk at each facility k is connected to a global server via an electric communication line (not shown) in a communicable manner. The global server collects parameters of each local model LMk, integrates the parameters, and generates a global model GM. The global server can send the parameter of the global model GM to the local learning apparatus of each facility k and reflect the parameter of the global model GM in the parameter of the local model LMk. In such federated learning, there are a method of aiming at improving the performance of the global model GM common to all facilities and a method of aiming at improving the performance of the local model LMk for each facility.

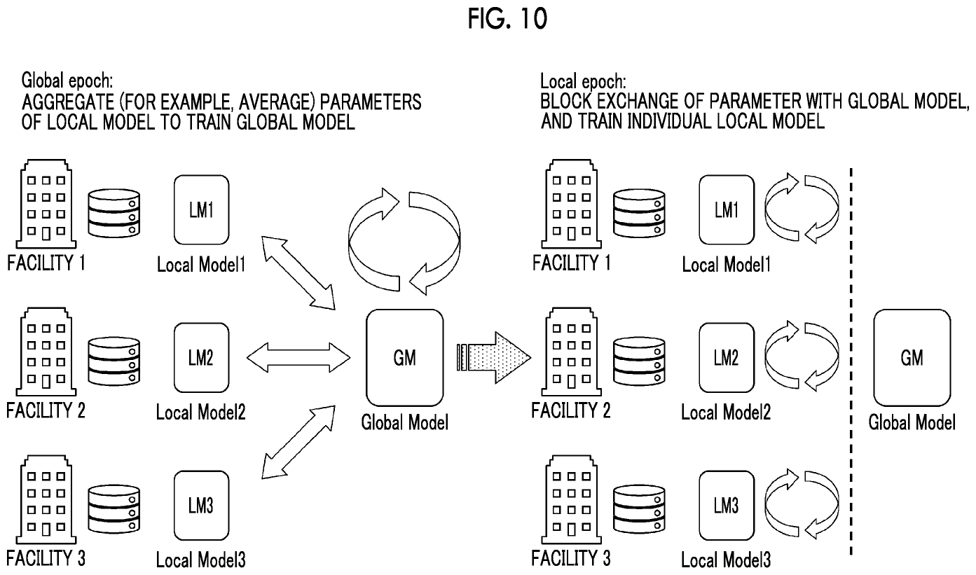

FIG. 10 is a conceptual diagram of a mechanism for training the global model GM and then training the local model LMk in federated learning. The left side in FIG. 10 represents a global epoch that is a learning process of the global model GM, and the right side in FIG. 10 represents a local epoch that is a learning process of the individual local model LMk.

In the global epoch, a global server GSV aggregates (for example, averages) the parameters of the individual local model LMk to train the global model GM. In the subsequent local epoch, the local learning apparatus of each facility k blocks the exchange (transfer) of the parameter with the global model GM, and trains the individual local model LMk for each facility.

The method as shown in FIG. 10 aims at improving the performance of the local model LMk in the individual facility k, and the performance of the model for other (unknown) facilities other than the facility k is not ensured.

Outline of Machine Learning Method According to Embodiment

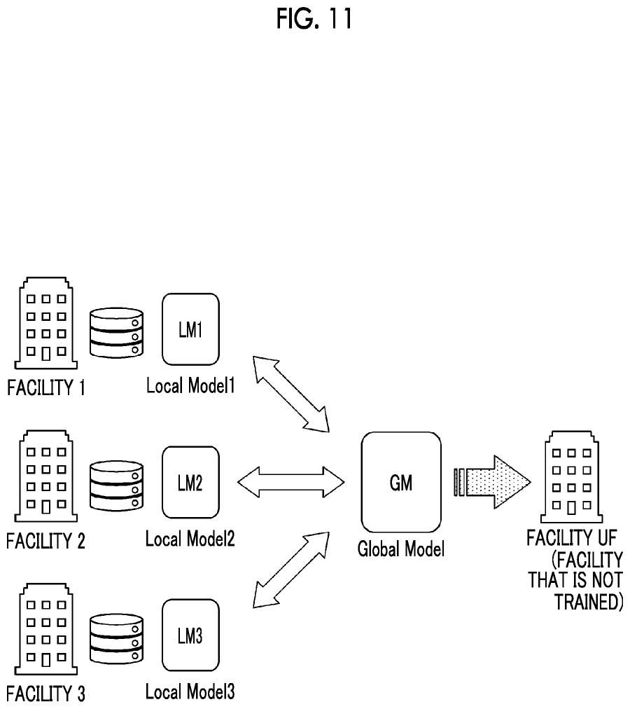

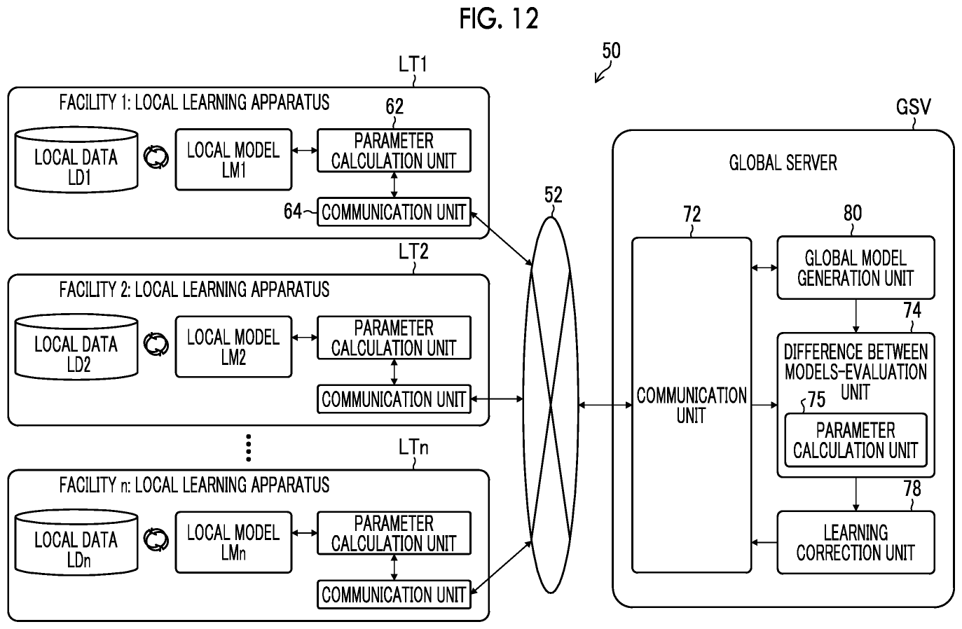

FIG. 11 is an explanatory diagram showing an outline of a machine learning method according to an embodiment of the present disclosure. In FIG. 11, an unknown facility (a facility that is not trained) different from the facility k where the training of each local model LMk is performed is referred to as a facility UF.

In the present embodiment, a model is trained such that the performance for the unknown facility UF is high. Therefore, a learning method of each local model LMk is controlled such that a difference between the local models LMk of the plurality of facilities k is small. An example of a specific control method will be described later, and the basic idea is as follows. That is, a relationship between the explanatory variable and the response variable in the model applied to the information suggestion includes a relationship specific to each facility and a universal relationship not depending on the facility. In a case where each local model LMk trains a prediction based on the facility-specific relationship, the difference between the local models LMk becomes large. On the contrary, in a case where each local model LMk trains a prediction based on a universal relationship that does not depend on the facility, a difference between the local models LMk becomes small. Therefore, in the present embodiment, by controlling the training such that the difference between the local models LMk of different facilities is small, it is induced to train a universal relationship that does not depend on the facility. As a result, it is possible to obtain a model having robust prediction performance against the differences in facilities.

Configuration Example of Machine Learning System

FIG. 12 is a block diagram showing an example of an overall configuration of the machine learning system 50 according to the embodiment. The machine learning system 50 includes a plurality of local learning apparatuses LTk corresponding to each of a plurality of facilities k (k=1, 2, . . . n) and a global server GSV that is connected to each local learning apparatus LTk via the electric communication line 52 in a communicable manner. The electric communication line 52 may be configured to include a wide area network such as the Internet. The machine learning system 50 is an example of the “information processing system” in the present disclosure.

The local learning apparatus LTk is an information processing apparatus that performs a process of training the local model LMk for each facility k by using local data LDk collected at the facility k. The local learning apparatus LTk may be, for example, a server built on a local area network of the facility k or may be a terminal device that can access data in the facility k.

The local data LDk includes a behavior history of a plurality of users on a plurality of items in the facility k. It is assumed that the local data LDk of each facility k is restricted from being taken out to the outside of the facility k, and the data cannot be shared between different facilities. The local data LDk of each facility k is stored in each of the facilities k, and the global server GSV cannot receive the local data LDk from the local learning apparatus LTk or other apparatuses in the facility k. The local data LDk is an example of “data for each facility” in the present disclosure.

The local model LMk is a learning model that is trained by using the local data LDk as learning data so as to predict the behavior of the user on the item. Each local learning apparatus LTk includes a parameter calculation unit 62 that updates a parameter of the local model LMk, and a communication unit 64. The parameter calculation unit 62 performs a process of calculating an update amount of the parameter and a process of updating the parameter. The communication unit 64 includes a communication interface that is connected to the electric communication line 52 and transfers information with the global server GSV.

The global server GSV includes a communication unit 72, a difference between models-evaluation unit 74, a learning correction unit 78, and a global model generation unit 80. The communication unit 72 includes a communication interface that is connected to the electric communication line 52 and transfers information with each local learning apparatus LTk. The difference between models-evaluation unit 74 performs a process of evaluating a difference between models based on the information on the local model LMk received from the local learning apparatus LTk. The difference between models-evaluation unit 74 includes a parameter calculation unit 75 that performs a calculation necessary for evaluating the difference between models by using parameter values of a plurality of local models LMk. The learning correction unit 78 performs control and the like to correct a training by the local learning apparatus LTk based on an evaluation result obtained from the difference between models-evaluation unit 74.

The global model generation unit 80 performs a process of generating a global model from the plurality of local models LMk based on the evaluation result obtained from the difference between models-evaluation unit 74.

Configuration Example of Local Learning Apparatus

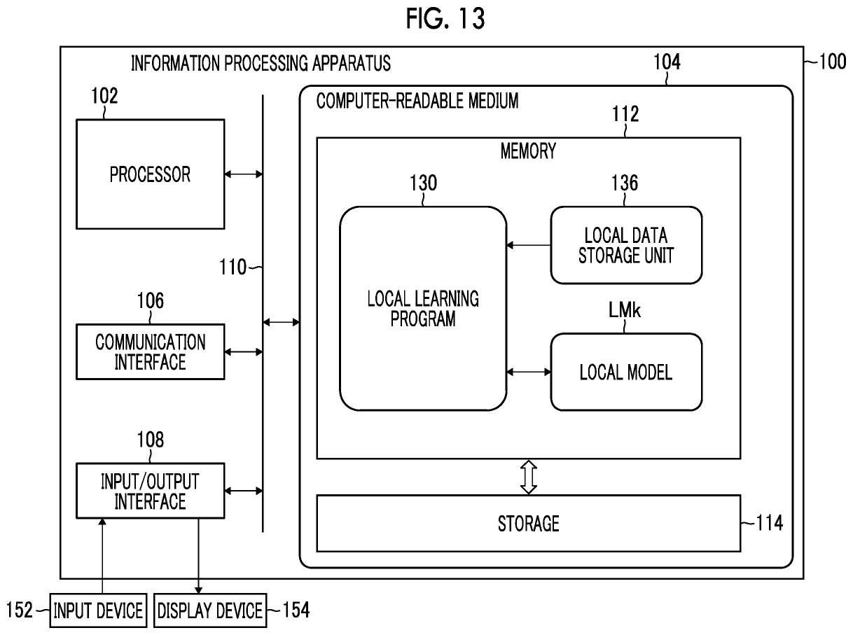

FIG. 13 is a block diagram showing an example of a hardware configuration of the information processing apparatus 100 that functions as the local learning apparatus LTk. The information processing apparatus 100 can be realized by using hardware and software of a computer. The physical form of the information processing apparatus 100 is not particularly limited, and may be a server, a workstation, a personal computer, a tablet terminal, or the like. Although an example of realizing a processing function of the information processing apparatus 100 using one computer will be described here, the processing function of the information processing apparatus 100 may be realized by a computer system configured by using a plurality of computers.

The information processing apparatus 100 includes a processor 102, a computer-readable medium 104 that is a non-transitory tangible object, a communication interface 106, an input/output interface 108, and a bus 110.

The processor 102 includes a central processing unit (CPU). The processor 102 may include a graphics processing unit (GPU). The processor 102 is connected to the computer-readable medium 104, the communication interface 106, and the input/output interface 108 via the bus 110. The processor 102 reads out various programs, data, and the like stored in the computer-readable medium 104 and executes various processes. The term program includes the concept of a program module and includes instructions conforming to the program. The processor 102 is an example of a “first processor” in the present disclosure. The computer-readable medium 104 is an example of a “first storage device” in the present disclosure.

The computer-readable medium 104 is, for example, a storage device including a memory 112 which is a main memory and a storage 114 which is an auxiliary storage device. The storage 114 is configured using, for example, a hard disk drive (HDD) device, a solid state drive (SSD) device, an optical disk, a photomagnetic disk, a semiconductor memory, or an appropriate combination thereof. Various programs, data, or the like are stored in the storage 114.

The memory 112 is used as a work area of the processor 102 and is used as a storage unit that temporarily stores the program and various types of data read from the storage 114. By loading the program that is stored in the storage 114 into the memory 112 and executing instructions of the program by the processor 102, the processor 102 functions as a unit for performing various processes defined by the program.

The memory 112 stores various programs such as a local learning program 130 executed by the processor 102 and a local model LMk, and various types of data. The local model LMk may be included in the local learning program 130. The memory 112 includes a local data storage unit 136. The local data storage unit 136 is a storage area in which a dataset (hereinafter, referred to as a local dataset) including the local data LDk collected at the facility k is stored.

The local learning program 130 is a program that uses the local data LDk to execute a process of training the local model LMk such that the prediction performance of the facility k is improved.

The communication interface 106 performs a communication process with an external device by wire or wirelessly and exchanges information with the external device. The information processing apparatus 100 is connected to a communication line (not shown) via the communication interface 106. The communication line may be a local area network, a wide area network, or a combination thereof. The communication interface 106 can play a role of, for example, a data acquisition unit that receives an input of various data such as a calculation result in the global server GSV, various instructions from the global server GSV, and a local dataset. Further, the communication interface 106 plays a role of a data output unit that transmits local model information, which includes a model parameter of the local model LMk, to the global server GSV.

The information processing apparatus 100 may include an input device 152 and a display device 154. The input device 152 and the display device 154 are connected to the bus 110 via the input/output interface 108. The input device 152 may be, for example, a keyboard, a mouse, a multi-touch panel, or other pointing device, a voice input device, or an appropriate combination thereof. The display device 154 may be, for example, a liquid crystal display, an organic electro-luminescence (OEL) display, a projector, or an appropriate combination thereof. The input device 152 and the display device 154 may be integrally configured as in the touch panel, or the information processing apparatus 100, the input device 152, and the display device 154 may be integrally configured as in the touch panel type tablet terminal.

Configuration Example of Global Server GSV

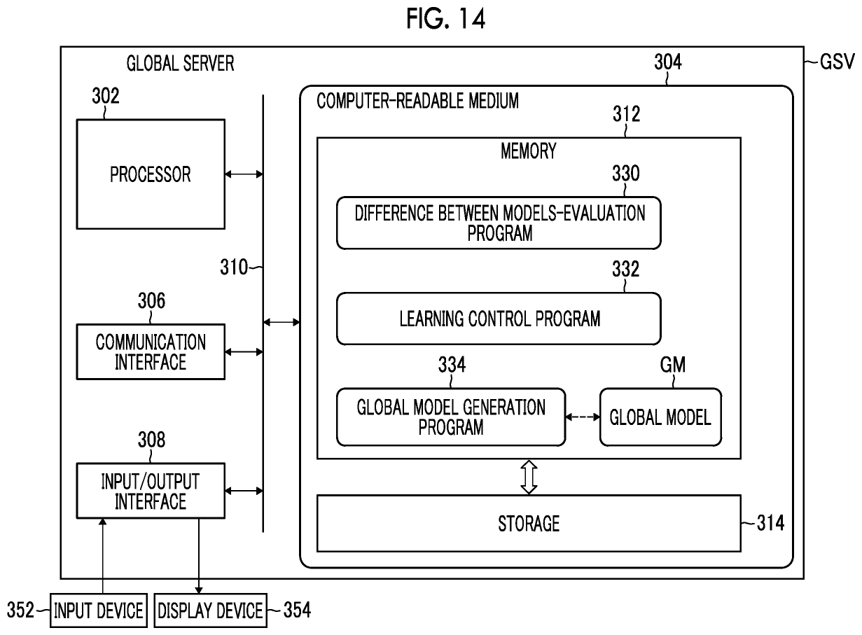

FIG. 14 is a block diagram showing an example of a hardware configuration of the global server GSV. The hardware configuration of the global server GSV may be the same as the hardware configuration of the information processing apparatus 100 described with reference to FIG. 13. The global server GSV includes a processor 302, a computer-readable medium 304, a communication interface 306, an input/output interface 308, and a bus 310. The computer-readable medium 304 includes a memory 312 and a storage 314. Further, the global server GSV may include an input device 352 and a display device 354. Each of the hardware configurations may be similar to the corresponding element of the configuration shown in FIG. 13.

The global server GSV is an example of a “server” in the present disclosure. The processor 302 is an example of a “second processor” in the present disclosure. The computer-readable medium 304 is an example of a “second storage device” in the present disclosure.

The memory 312 stores various programs such as a difference between models-evaluation program 330, a learning control program 332, a global model generation program 334, and the global model GM executed by the processor 302, and various types of data.

The difference between models-evaluation program 330 is a program that acquires local model information, which includes a model parameter of each local model LMk, and executes a process of evaluating differences between models of the plurality of local models LMk based on the acquired local model information. The learning control program 332 is a program that executes a process of controlling a training of the local model LMk in each facility k such that a difference between the local models of the local models LMk is small based on the evaluation result of the difference between the models. The control of a training by using the learning control program 332 includes a concept of correcting a training based on a prediction error of the local model LM. An example of a specific correction method (control method) will be described later.

The global model generation program 334 is a program that executes a process of generating the global model GM based on the local model information received from each local learning apparatus LTk.

First Example of Machine Learning Method: Regularization Approach

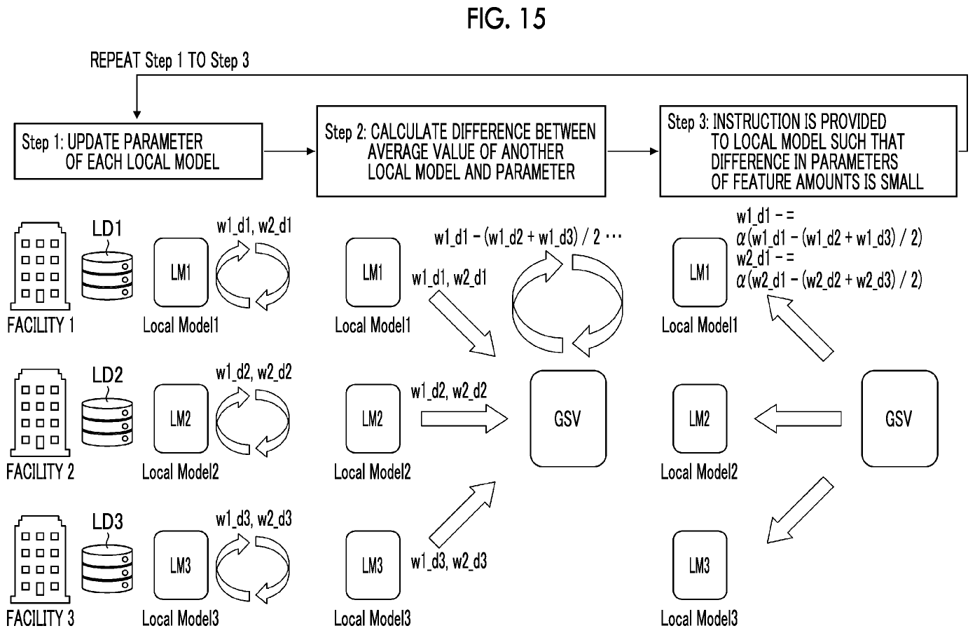

FIG. 15 is an explanatory diagram showing an outline of a first example of the machine learning method performed by the machine learning system 50 according to the embodiment.

Here, an example of regularization (domain regularization) for domain generalization will be shown. FIG. 15 shows a case where a prediction equation of the local model LMk of the facility k is represented by the following Equation (1) for convenience of explanation.

y=w1_dk*x1+w2_dk*x2 (1)

Each of x1 and x2 in the expression is a feature amount related to the explanatory variable. w1_dk and w2_dk are parameters indicating the respective weights of the feature amounts x1 and x2. The local model LMk is not limited to the representation of Expression (1), and may have a configuration including a large number of combinations of feature amounts and weights.

The machine learning system 50 repeatedly executes the following steps 1 to 3.

Step 1

In Step 1, the local learning apparatus LTk performs a training by using the local data LDk of each of the facilities k and updates the parameter of the local model LMk. The local learning apparatus LTk updates the parameter based on a prediction error of the local model LMk so as to reduce the prediction error.

Step 2

In Step 2, the global server GSV acquires the parameters of each local model LMk and calculates a difference between an average value of another local model and the parameter for each local model LMk. For example, the global server GSV calculates a difference between the parameter w1_d1 of the local model LM1 and an average value (w1_d2+w1_d3)/2 of the other local models LM2 and LM3. Further, the global server GSV calculates a difference between the parameter w2_d1 of the local model LM1 and an average value (w2_d2+w2_d3)/2 of the other local models LM2 and LM3. Similarly for the local models LM2 and LM3, the global server GSV calculates a difference between an average value of the other local models and the parameter. A value of the difference between the parameters calculated here corresponds to a value of the partial differentiation of a loss component introduced for the domain regularization.

Step 3

In Step 3, the global server GSV gives an instruction to the local model LMk such that a difference between the parameters of each of the feature amounts is small. For example, the global server GSV instructs the local learning apparatus LT1 to update the parameter w1_d1 of the local model LM1 to a value of w1_d1−α(w1_d1−(w1_d2+w1_d3)/2). α is a hyper parameter representing a learning rate (learning speed).

Further, the global server GSV instructs the local learning apparatus LT1 to update the parameter w2_d1 of the local model LM1 to a value of w2_d1−α(w2_d1−(w2d2+w2_d3)/2).

The global server GSV may give an instruction of a value of “−α(w1_d1−(w1_d2+w1_d3)/2)” which is an update amount of the parameter and a value of “−α(w2_d1−(w2_d2+w2_d3)/2)” to the local learning apparatus LT1, and may make an instruction of a value of “w1d1−α(w1 d1−(w1_d2+w1_d3)/2)” which is a parameter value after the update and a value of “w2_d1−α(w2_d1−(w2d2+w2_d3)/2)” to the local learning apparatus LT1. Further, the global server GSV may make an instruction of a value, such as a value used to calculate the update amount of the parameter, for example, “w1_d1−(w1_d2+w1_d3)/2” and “w2_d1−(w2_d2+w2_d3)/2”, or “(w1_d2+w1_d3)/2” and “(w2_d2+w2_d3)/2” to the local learning apparatus LT1, and may calculate the update amount of the parameter on the local learning apparatus LT1 side.

Similarly, for the other local models LM2 and LM3, the global server GSV gives an instruction of updating the parameter of the local model such that the difference between the parameters of each of the feature amounts is small.

In accordance with the instruction in Step 3, the parameter of each local model LMk is updated in Step 1. The machine learning system 50 repeats Steps 1 to 3, and transitions to Step 4 in a case where a predetermined end condition is satisfied. The end condition may be that, for example, it reaches a predetermined number of iterations, or a difference between models is within an allowable range.

Step 4

In Step 4, the global server GSV builds the global model GM based on the local models LM1 to LM3. As a method for building the global model GM, for example, the following methods 1 to 3 can be used.

Method 1: repeating Steps 1 to 3 until all the local models LMk converge to the same parameters, and after converging all the local models LMk to the same parameters, one of the models is adopted as the global model GM.

Method 2: adopting an average of all the local models LMk as the global model GM.

Method 3: selecting the optimal local model, as the global model GM, based on the small difference in the parameters and high prediction performance among all the local models LMk. Alternatively, a weighted average is taken by using the difference in the parameters and an evaluation value of the prediction performance, and a model, on which the weighted average is performed, is adopted as the global model GM.

The facility 1 in FIG. 15 is an example of a “first facility” in the present disclosure, and the local data LD1 and the local model LM1 are examples of “first data” and a “first local model” in the present disclosure. Each of the other facility 2 and the facility 3 with respect to the facility 1 is an example of a “second facility” in the present disclosure, and each of the local data LD2 and the local data LD3 is an example of “second data” in the present disclosure. Further, each of the other local model LM2 and the local model LM3 with respect to the local model LM1 is an example of a “second local model” in the present disclosure.

The same applies to the facility 2 and the facility 3, and each of the facility 2 and the facility 3 is an example of a “first facility” in the present disclosure.

Example of Loss Function of Regularization for Domain Generalization

The loss function L applied to the training of the local model LM1 of the facility 1 is configured to include, for example, a prediction error portion and a domain regularization portion as in the following Equation (2).

L=(y−y_true)²+(w1_d1−(w1_d2+w1_d3)/2)²+(w2_d1−(w2_d2+w2_d3)/2)² (2)

The first term on the right side of Equation (2) is a loss component of the prediction error portion, and the second term and the third term are loss components of the domain regularization portion.

Here, the prediction equation of the response variable y is represented by Equation (3).

y=w1_d1*x1+w2_d1*x2 (3)
y_true in Equation (2) is a correct answer value (teacher signal) of the response variable in the learning data.

In the case of the training of the local model LM1, the loss function L represented by Equation (2) is partially differentiated by the respective parameters w1_d1 and w2_d1, and the respective parameters are updated. Naturally, the value of the partial differentiation of the loss function L is also divided into a prediction error portion and a domain regularization portion.

Since the prediction error portion in Equation (2) includes y_true of the learning data, it is necessary to calculate on the local learning apparatus LT1 side. In contrast to this, the domain regularization portion may be calculated on the global server GSV or may be calculated on the local learning apparatus LT1 side. In the description in FIG. 15, an example is shown in which the global server GSV side calculates the domain regularization portion and provides an instruction to the local learning apparatus LT1 side.

The update method of the parameter can be roughly divided into the following two methods.

Case 1: A mode in which the partial differentiation between the prediction error portion and the domain regularization portion is updated together.

Case 2: A mode in which an update based on the partial differentiation of the prediction error portion and an update based on the partial differentiation of the domain regularization portion are “alternately” performed.

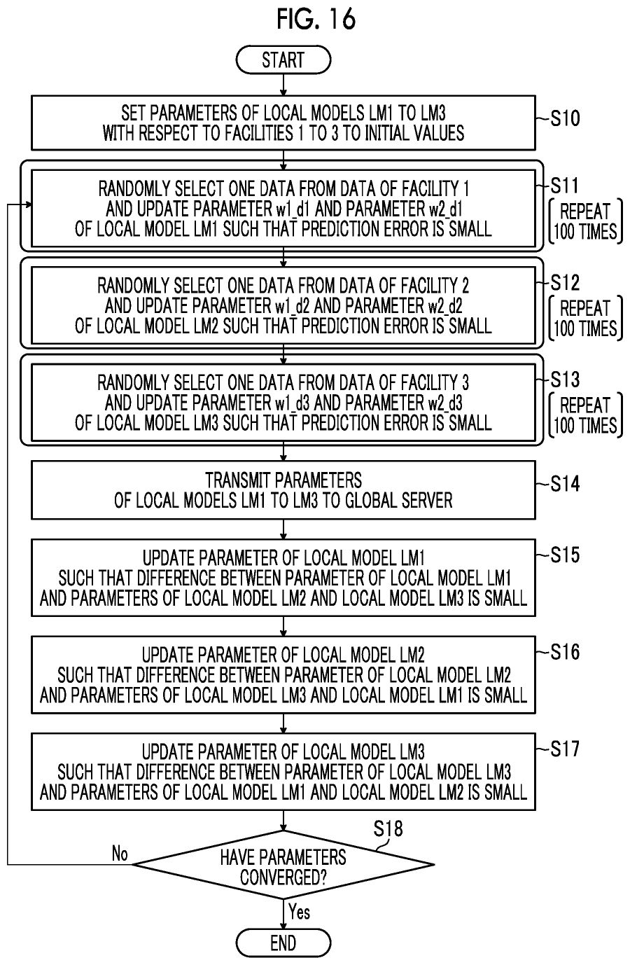

FIG. 15 shows the method of Case 2. Here, “alternately” does not mean “alternate” in units of one sample, but means that a fixed number of samples (for example, 100 samples) are updated only with the prediction error, next update is performed with the domain regularization, and then again, the fixed number of samples are updated only with the prediction error, . . . are alternately repeated. A specific example of the method of Case 2 will be described with reference to the flowchart in FIG. 16.

FIG. 16 is a flowchart showing the first example of the machine learning method according to the embodiment. In step S10, the global server GSV sets parameters of each of the local models LM1 to LM3 with respect to the plurality of facilities 1 to 3 to initial values. For example, a normal distribution having an average value of 0 and a standard deviation of 0.1 may be set to a random value.

In step S11, the local learning apparatus LT1 randomly selects one data from the data of the facility 1, and updates the parameters w1_d1 and w2_d1 of the local model LM1 such that the prediction error is small. The local learning apparatus LT1 repeats this update process 100 times, for example.

In step S12, the local learning apparatus LT2 randomly selects one data from the data of the facility 2, and updates the parameters w1_d2 and w2_d2 of the local model LM2 such that the prediction error is small. The local learning apparatus LT1 repeats this update process 100 times, for example.

In step S13, the local learning apparatus LT3 randomly selects one data from the data of the facility 3, and updates the parameters w1_d3 and w2_d3 of the local model LM3 such that the prediction error is small. The local learning apparatus LT3 repeats this update process 100 times, for example.

Step S11 to step S13 may be performed in parallel in the local learning apparatuses LT1 to LT3 of each facility. Further, a timing at which steps S11 to S13 are performed may be freely set for each facility, and the order of performance of steps S11 to S13 is not limited.

Thereafter, in step S14, each local learning apparatus LTk transmits the parameters of the local models LM1 to LM3 to the global server GSV.

In step S15, the global server GSV updates the parameter of the local model LM1 based on the obtained parameters of each local model LMk such that a difference between the parameter of the local model LM1 and the parameters of the local models LM2 and LM3 is small.

In step S16, the global server GSV updates the parameter of the local model LM2 based on the obtained parameters of each local model LMk such that a difference between the parameter of the local model LM2 and the parameters of the local models LM3 and LM1 is small.

In step S17, the global server GSV updates the parameter of the local model LM3 based on the obtained parameters of each local model LMk such that a difference between the parameter of the local model LM3 and the parameters of the local models LM1 and LM2 is small.

In step S15 to step S17, based on the parameters received by the global server GSV, the change amount in the parameters of each local model LMk is obtained, the parameters in the global server GSV are updated, the updated parameters are transmitted to each local learning apparatus LTk, and the parameters in the local model LMk are also updated.

In step S18, the global server GSV determines whether or not the parameters have converged. In a case where the determination result in step S18 is a No determination, that is, in a case where the parameters have not converged, the process returns to step S11, and steps S11 to S17 are repeated.

On the other hand, in a case where the determination result in step S18 is a Yes determination, that is, in a case where the parameters have converged, the flowchart in FIG. 16 is ended.

### Example 1 of Functional Configuration of Information Processing Apparatus 100

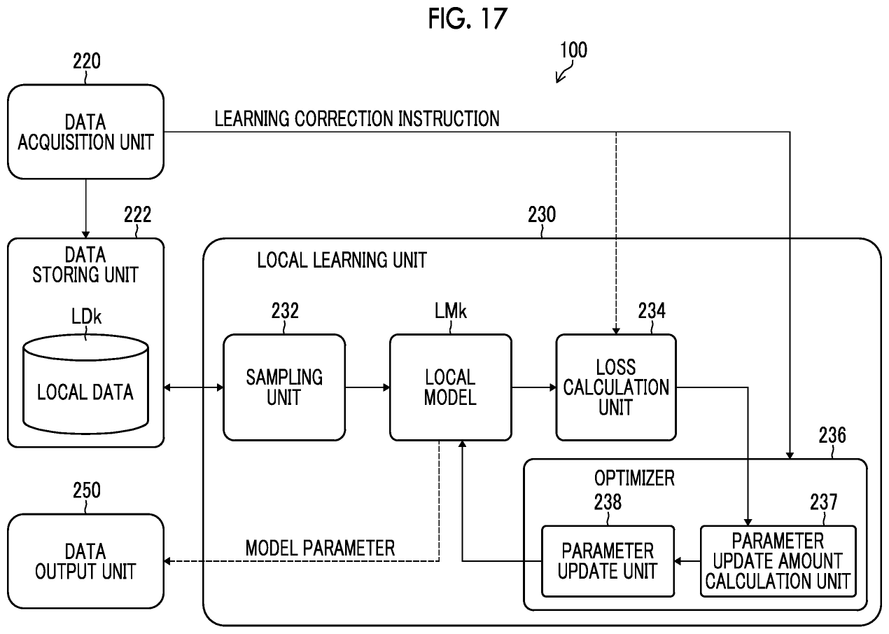

FIG. 17 is a functional block diagram showing Example 1 of a functional configuration of the information processing apparatus 100 that functions as the local learning apparatus LTk. The information processing apparatus 100 shown in FIG. 17 performs the training of the local model LMk in accordance with an instruction of the global server GSV such that the difference between the models is made to be small by using the domain regularization, as described with reference to FIG. 15 and FIG. 16.

The information processing apparatus 100 includes a data acquisition unit 220, a data storing unit 222, a local learning unit 230, and a data output unit 250. The data acquisition unit 220 acquires the local data LDk collected at the facility k. The information processing apparatus 100 may be provided with a function of collecting the local data LDk. Further, the data acquisition unit 220 acquires various types of data such as a learning correction instruction from the global server GSV.

The local data LDk, which is acquired via the data acquisition unit 220, is stored in the data storing unit 222. The local data storage unit 136 (see FIG. 13) is included in the data storing unit 222.

The local learning unit 230 includes a sampling unit 232, a local model LMk, a loss calculation unit 234, and an optimizer 236, and performs a training of the local model LMk by using the local data LDk. The sampling unit 232 samples learning data from a dataset of the local data LDk. For example, in a case where the parameter is optimized by using a stochastic gradient descent (SGD) method, the sampling unit 232 selects one record from the dataset for a training for each step of a training. This operation is repeated until the prediction error of the local model LMk converges.

The learning data sampled by the sampling unit 232 is input to the local model LMk, and the prediction result corresponding to the input data is output from the local model LMk. The local model LMk is built as a mathematical model that predicts a behavior of a user on an item. Since the sampling unit 232 probabilistically samples the record used as the input of the local model LMk from the dataset, within a range of probabilistic fluctuations, the number of times used for training may vary.

Based on the prediction (inference) result output from the local model LMk and the correct answer data (teacher data) associated with the input data, the loss calculation unit 234 calculates a loss value (loss) between the prediction result and the correct answer data.

The optimizer 236 determines the update amount of a parameter of the local model LMk such that the prediction result, which is output by the local model LMk, approaches the correct answer data, based on the calculation result of the loss and performs an update process on the parameter of the local model LMk. The optimizer 236 includes a parameter update amount calculation unit 237 that calculates an update amount of a parameter, and a parameter update unit 238 that performs an update process on a parameter. The optimizer 236 updates the parameter based on an algorithm such as a gradient descent method.

The local learning unit 230 may acquire the learning data one sample at a time and update the parameter, or may perform acquisition of the learning data and update of the parameter in units of a mini-batch in which a plurality of learning data are collected.

In this way, by performing machine learning by using the learning data sampled from the dataset of the local data LDk, the parameter of the local model LMk is optimized, and the local model LMk that has the desired prediction performance is generated.

Local model information including the model parameter of the local model LMk is transmitted to the global server GSV via the data output unit 250.

Further, the local learning unit 230 updates the parameter of the local model LMk in response to the learning correction instruction received from the global server GSV. In a case where the learning correction instruction from the global server GSV includes an instruction of the update amount of the parameter, the parameter update unit 238 updates the parameter of the local model LMk with the update amount instructed from the global server GSV. In a case where the learning correction instruction from the global server GSV includes an instruction such as a partial value of the loss function or a value used to calculate the parameter update amount, the loss calculation unit 234 and/or the parameter update amount calculation unit 237 calculate a loss value and/or a parameter update amount by using the value instructed from the global server GSV. The parameter update unit 238 updates the parameter of the local model LMk based on the value instructed from the global server GSV.

The parameter calculation unit 62 shown in FIG. 12 includes the loss calculation unit 234 and the parameter update amount calculation unit 237, and the communication unit 64 shown in FIG. 12 can function as the data acquisition unit 220 and the data output unit 250.

### Example 1 of Functional Configuration of Global Server GSV

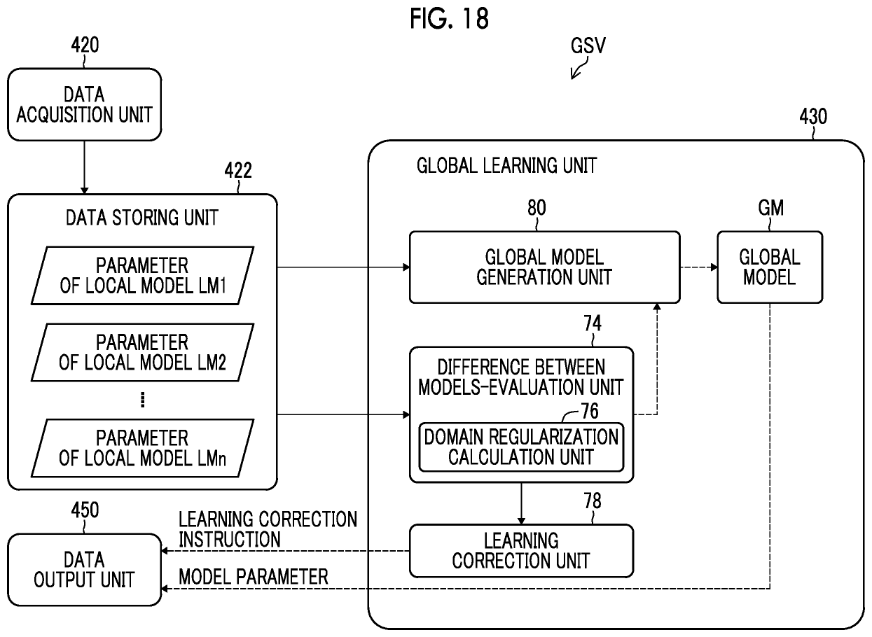

FIG. 18 is a functional block diagram showing Example 1 of a functional configuration of the global server GSV. As described with reference to FIG. 16 and FIG. 17, the global server GSV shown in FIG. 18 controls the training of the local model LMk such that the difference between the models is made to be small by using the domain regularization.

The global server GSV includes a data acquisition unit 420, a data storing unit 422, a global learning unit 430, and a data output unit 450. The data acquisition unit 420 acquires local model information including the parameter of the local model LMk from the local learning apparatus LTk of each facility k. The data acquisition unit 420 may acquire only the parameter of the local model LMk or may acquire all the information necessary for specifying the local model LMk (for example, a copy of the local model LMk).

A value of the parameter of each local model LMk acquired through the data acquisition unit 420 is stored in the data storing unit 422.

The global learning unit 430 includes a difference between models-evaluation unit 74, a learning correction unit 78, and a global model generation unit 80. The difference between models-evaluation unit 74 includes a domain regularization calculation unit 76. As described in step 2 in FIG. 16, the domain regularization calculation unit 76 performs a calculation of the domain regularization portion in the loss function L.

The learning correction unit 78 provides an instruction to correct the training of the local model LMk based on the calculation result of the difference between models-evaluation unit 74. For example, the learning correction unit 78 outputs a learning correction instruction as a control signal for instructing the update of the parameter of the local model LMk together with the value of the partial differentiation of the domain regularization portion calculated by the domain regularization calculation unit 76. The learning correction instruction from the learning correction unit 78 is transmitted to the local learning apparatus LTk via the data output unit 450.

The global model generation unit 80 builds the global model GM based on the acquired parameter of the local model LMk. The global model generation unit 80 generates the global model GM after the parameter of each local model LMk has converged by repeating Step 1 to Step 3 described with reference to FIG. 15.

Further, even in a step where the parameter of the local model LMk has not converged, the global model generation unit 80 may generate a temporary global model GM by using the latest parameter of the local model LMk and may update the parameter of the global model GM in response to updating the parameter of the local model LMk. The model parameter of the global model GM can be transmitted to an external device such as the local learning apparatus LTk via the data output unit 450.

Difference Between Domain Regularization and General Regularization

The concept of “regularization” for the domain generalization in the present embodiment is different from the generalization (for example, Li regularization) that is generally used in machine learning. Regarding the general regularization, for example, in a case where a model of Lasso regression is shown as an example, the model and the loss function can be represented, for example, as in Equation (4) and Equation (5), respectively.

y=w1*x1+w2*x2 (4)

L=(y−y_true)²+|w1|+|w2| (5)

In this case, the first term on the right side of Equation (5) is a prediction error portion. It is a general regularization to introduce a loss such that an insignificant parameter becomes small (to zero) as in the second and the third terms.

In contrast to this, regarding the regularization for the domain generalization (domain regularization), for example, a loss function such as Equation (8) is used, for example, in a case where a prediction model of domain 1 is represented by Equation (6) and a prediction model of domain 2 is represented by Equation (7).

y=w1_d1*x1+w2_d1*x2 (6)

y=w1_d2*x1+w2_d2*x2 (7)

L=(y−y_true)²+|w1_d1−w1_d2|+|w2_d1−w2_d2| (8)

As described in the second term and the third term on the right side of Equation (8), in the domain regularization, it refers to introduce a loss such that the difference in the parameters between the domains is small.

In the description in FIG. 15, in order to evaluate the difference in the parameters between the domains, instead of the second term and the third term of Equation (8), the domain regularization portion such as the second term and the third term of Equation (2) is used.

Second Example of Machine Learning Method: Feature Amount Selection Approach

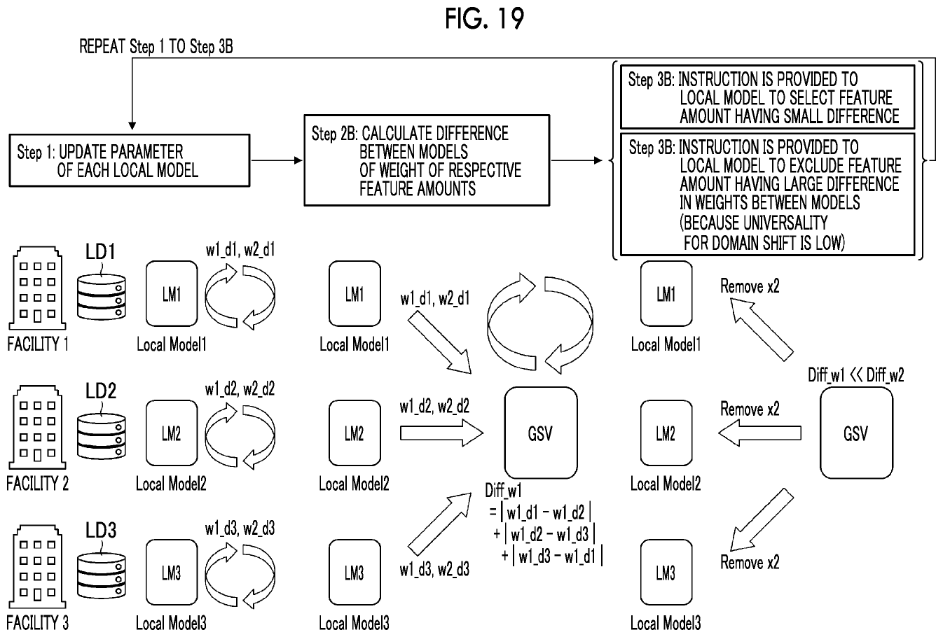

FIG. 19 is an explanatory diagram illustrating an outline of a second example of the machine learning method performed by the machine learning system 50. Here, an example is shown in which the difference between the models is made to be small by selecting the feature amount in the model. A difference from FIG. 15 will be described with reference to FIG. 19. Step 1 in FIG. 19 is the same as Step 1 in FIG. 15. Step 2B to Step 3B are performed instead of Steps 2 to 3 in FIG. 15.

Step 2B

In Step 2B, the global server GSV acquires a parameter of each local model LMk and calculates a difference between the models of the weight (parameter) of the respective feature amounts. The global server GSV calculates, for example, the difference between the models of the weights of the feature amount x1 by using the following Equation (9).

Diff_w1=|w1_d1−w1_d2|+|w1_d2−w1_d3|+|w1_d3−w1_d1|(9)

Similarly, the difference between the models of the weights of the feature amount x2 is calculated by using the following Equation (10).

Diff_w2=|w2_d1−w2_d2|+|w2_d2−w2_d3|+|w2_d3−w2_d1| (10)

Here, although the weights of the two feature amounts x1 and x2 are illustrated, in reality, the difference between the models is calculated for the respective weights of a large number of feature amounts.

Step 3B

In Step 3B, the global server GSV instructs the local model LMk to select (remain) the feature amount having a small difference in weights between the models. Further, the global server GSV instructs the local model LMk to exclude the feature amount having a large difference in weights between the models. This is because the feature amount having a large difference in weights between the models has low universality for the domain shift.

For example, as shown in FIG. 19, in a case where the difference between the models in the weights of the feature amount x2 is very large, the global server GSV provides an instruction to the local model LMk to exclude the feature amount x2.

Regarding Model Representation and Cross Feature Amount

In the case of the suggestion technique, the interaction between the feature amounts is often important, and therefore it is preferable to consider the cross feature amounts as well. For example, the local model LMk can be represented as the following Equation (11).

y=(w_11_d1*x_u1*x_i1+w_12_d1*x_u1*x_i2+w_13_d1*x_u1*x_i3)+(w_21_d1*x_u2*x_i1+w_22_d1*x_u2*x_i2+w_23_d1*x_u2*x_i3)+(w_31_d1*x_u3*x_i1+w_32_d1*x_u3*x_i2+w_33_d1*x_u3*x_i3)+(w_u1_d1*x_u1+w_u2_d1*x_u2+w_u3_d1*x_u3)+(w_i1_d1*x_i1+w_i2_d1*x_i2+w_i3_d1*x_i3) (11)

Each of x_u1, x_u2, and x_u3 in Equation (11) has a value of 1 in a case where a certain user “u” corresponds to the user attributes 1, 2, and 3, and 0 otherwise. Further, each of x_i1, x_i2, and x_i3 in Equation (11) has a value of 1 in a case where a certain item “i” corresponds to the item attributes 1, 2, and 3, and 0 otherwise.

For example, in the case of a model that predicts user purchases of items, a portion “(w_11_d1*x_u1*x_i1+w_12_d1*x_u1*x_i2+w_13_d1*x_u1*x_i3)+(w_21_d1*x_u2*x_i1+w_22_d1*x_u2*x_i2+w_23_d1*x_u2*x_i3)+(w_31_d1*x_u3*x_i1+w_32_d1*x_u3*x_i2+w_33_d1*x_u3*x_i3)”, which is the sum of the first term to the ninth term on the right side of Equation (11), is a portion that evaluates whether or not there is a high probability that a user with a certain user attribute will purchase an item with a certain item attribute.

The sum portion “(w_u1_d1*x_u1+w_u2_d1*x_u2+w_u3_d1*x_u3)” of the tenth term through the twelfth term on the right side of Equation (11) is a portion that evaluates whether or not a user with a certain user attribute has a high purchase rate. The sum portion “(w_i1_d1*x_i1+w_i2_d1*x_i2+w_i3_d1*x_i3)” of the thirteenth term through the fifteenth term on the right side of Equation (11) is a portion that evaluates whether or not an item of a certain item attribute is likely to be purchased.

The loss of the domain regularization described with reference to FIG. 15 can be similarly defined with respect to the weight of the cross feature amount. For example, as the domain regularization portion in the loss function, a loss of the domain regularization as in the following Equation (12) can be introduced.

(w_11_d1−(w_11_d2+w_11_d3)/2)²+(w_12_d1−(w_12_d2+w_12_d3)/2)²+ (12)

Further, regarding the feature amount selection with respect to the cross feature amount, for example, in a case where |w_32_d1−(w_32_d2+w32_d3)/21 is large, the combination of x_u3*x_i2 (cross feature amount) is excluded from the prediction model. In this case, the term of the cross feature amount x_u3*x_i2 is deleted from Equation (11), and the prediction equation is as shown in the following Equation (13).

y=(w_11_d1*x_u1*x_i1+w_12_d1*x_u1*x_i2+w_13_d1*x_u1*x_i3)+(w_21_d1*x_u2*x_i1+w_22_d1*x_u2*x_i2+w_23_d1*x_u2*x_i3)+(w_31_d1*x_u3*x_i1+w_33_d1*x_u3*x_i3)+(w_u1_d1*x_u1+w_u2_d1*x_u2+w_u3_d1*x_u3)+(w_i1_d1*x_i1+w_i2_d1*x_i2+w_i3_d1*x_i3) (13)

### Example 1 of Weight Representation of Cross Feature Amount

The weights of the cross feature amounts may be calculated based on the embedding representations of the individual feature amounts. For example, in a case where a vector of the user attribute 1 in the domain d1 is defined as Vk_u\hat{ }1_d1 and a vector of the item attribute 2 is defined as V_i\hat{ }2_d1, the weight w_12_d1 of the cross feature amount of the user attribute 1 and the item attribute 2 can be represented by the following Equation (14).

w_12_d1=f(Vk_u\hat{ }1_d1,Vk_i\hat{ }2_d1)=Vk_u\hat{ }1_d1−Vk_i\hat{ }2_d1 (14)
“f” is any function, and may be, for example, an inner product.

The weights of other cross feature amounts can be represented in the same manner.

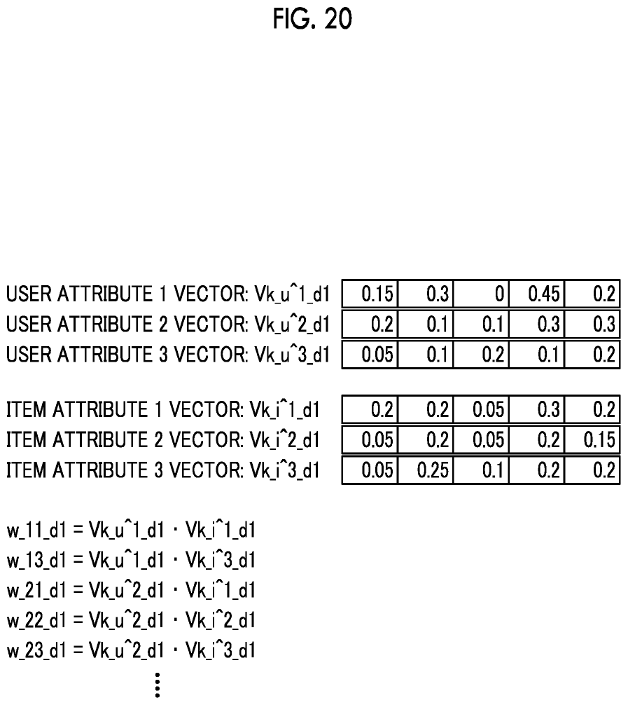

FIG. 20 shows an example of a vector representation of each of the user attribute and the item attribute in the domain d1. Here, examples of the user attributes 1 to 3 and the item attributes 1 to 3 are shown, and an example in which each attribute is represented by a five-dimensional vector is shown.

In this case, the weight of the cross feature amount is represented by a function of a combination of the two attribute vectors, for example, an inner product, as in Equation (14). Similar representations are possible in other domains d2, d3, . . . .

### Example 2 of Weight Representation of Cross Feature Amount

The feature amounts x1 and x2 used in the prediction equation of the model are not limited to the attribute data and may correspond to a user or an item at an ID level. For example, in a case where the user ID is “u” and the item ID is “i”, the cross feature amount at the ID level is represented by the following Equation (15).

y=w_ui_d1=θu_d1·φi_d1 (15)
θu_d1 and φi_d1 represent a vector in which the user ID is “u” and a vector in which the item ID is “i”, in the domain d1.

In a case where the user ID is “uₐ” and the item ID is “iₐ”, the cross feature amount at the ID level is represented by the following Equation (16).

y=w_uₐiₐ_d1=θuₐd1·φiₐ_d1 (16)

Further, the prediction equation may be a combination of the cross feature amount at the ID level and the cross feature amount at the attribute level. For example, the prediction equation may be represented as the following Equation (17).

y=w_ui_d1+(w_11_d1*x_u1*x_i1+w_12_d1*x_u1*x_i2+w_13_d1*x_u1*x_i3)+(w_21_d1*x_u2*x_i1+w_22_d1*x_u2*x_i2+w_23_d1*x_u2*x_i3)+(w_31_d1*x_u3*x_i1+w_32_d1*x_u3*x_i2+w_33_d1*x_u3*x_i3)+(w_u1_d1*x_u1+w_u2_d1*x_u2+w_u3_d1*x_u3)+(w_i1_d1*x_i1+w_i2_d1*x_i2+w_i3_d1*x_i3) (17)

The same applies to the other domains d2, d3, . . . .

### Example 2 of Functional Configuration of Information Processing Apparatus 100

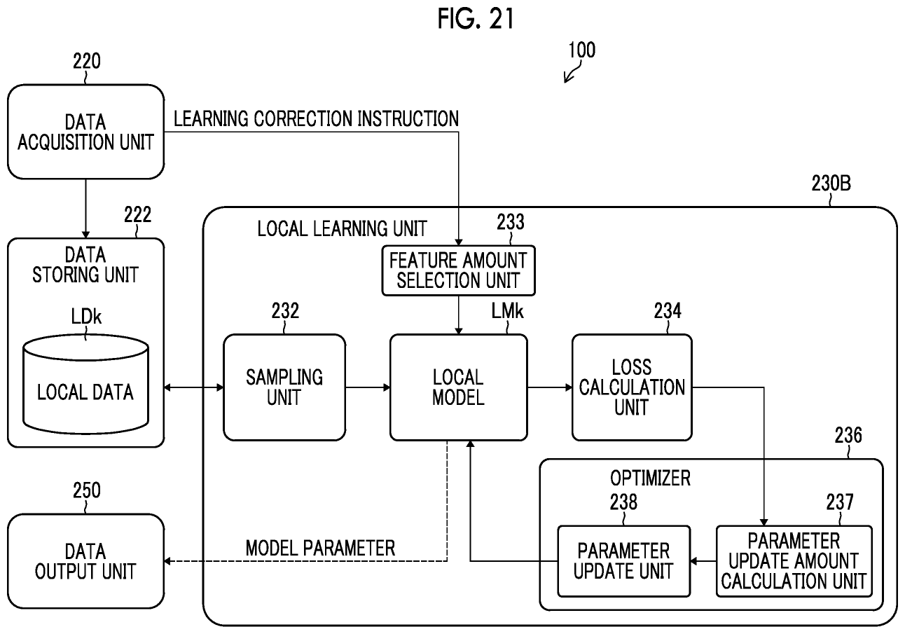

FIG. 21 is a functional block diagram showing Example 2 of a functional configuration of the information processing apparatus 100 that functions as the local learning apparatus LTk. The information processing apparatus 100 shown in FIG. 21 performs the training of the local model LMk in accordance with an instruction of the global server GSV such that the difference between the models is small by the feature amount selection described in FIG. 19. Regarding the configuration shown in FIG. 21, the elements common to those in FIG. 17 are designated by the same reference numerals, and redundant description will be omitted. The information processing apparatus 100 shown in FIG. 21 includes a local learning unit 230B instead of the local learning unit 230 in FIG. 17. The local learning unit 230B includes a feature amount selection unit 233 that selects a feature amount of the local model LMk based on the learning correction instruction from the global server GSV. Based on the learning correction instruction from the global server GSV, the feature amount selection unit 233 performs a process of updating the local model LMk by deleting the feature amount having a relatively large difference in parameters between the models. Other configurations may be the same as in FIG. 17.

The information processing apparatus 100 may perform both the update process of the parameter by using the domain regularization and the update process of the model by using the feature amount selection described with reference to FIG. 17.

### Example 2 of Functional Configuration of Global Server GSV

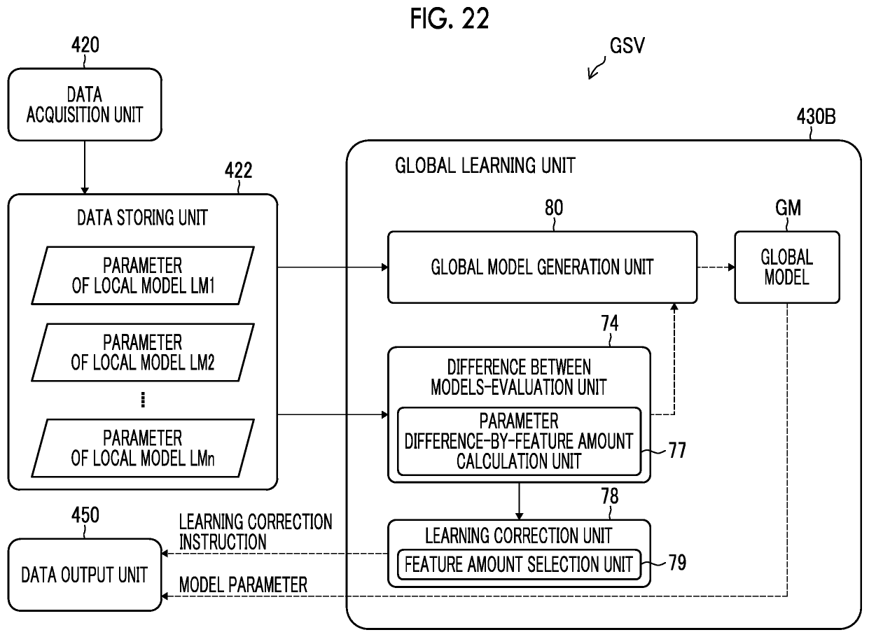

FIG. 22 is a functional block diagram showing Example 2 of a functional configuration of the global server GSV. The global server GSV shown in FIG. 22 evaluates the difference in parameters between the models for each feature amount and selects the feature amount so as to delete the feature amount having a large difference in the parameters. Regarding the configuration shown in FIG. 22, the elements common to those in FIG. 18 are designated by the same reference numerals, and redundant description will be omitted. The global server GSV shown in FIG. 22 includes a global learning unit 430B instead of the global learning unit 430 in FIG. 18. The difference between models-evaluation unit 74 of the global learning unit 430B includes a parameter difference-by-feature amount calculation unit 77 that evaluates a difference (difference between weight models) in parameters between the models for each feature amount. The parameter difference-by-feature amount calculation unit 77 performs a process of step 2B in FIG. 19. Further, the learning correction unit 78 includes a feature amount selection unit 79 that selects a feature amount based on a calculation result of the parameter difference-by-feature amount calculation unit 77. The feature amount selection unit 79 performs a process of step 3B in FIG. 19. Other configurations may be the same as in FIG. 19.

Note that, in the global learning unit 430B, a corrected local model LMk, in which the feature amount is selected, may be generated, and the local model LMk, for which this feature amount selection has been performed, may be returned to the local learning apparatus LTk side. In this case, the information processing apparatus 100 updates the stored local model LMk to the local model LMk received from the global server GSV. The processing function of the feature amount selection unit 233 of the information processing apparatus 100 described with reference to FIG. 21 may be included in the feature amount selection unit 79 of the global server GSV.

The global server GSV may perform both a calculation process of the domain regularization and a process of the feature amount selection described with reference to FIG. 18.

### Specific Application Example

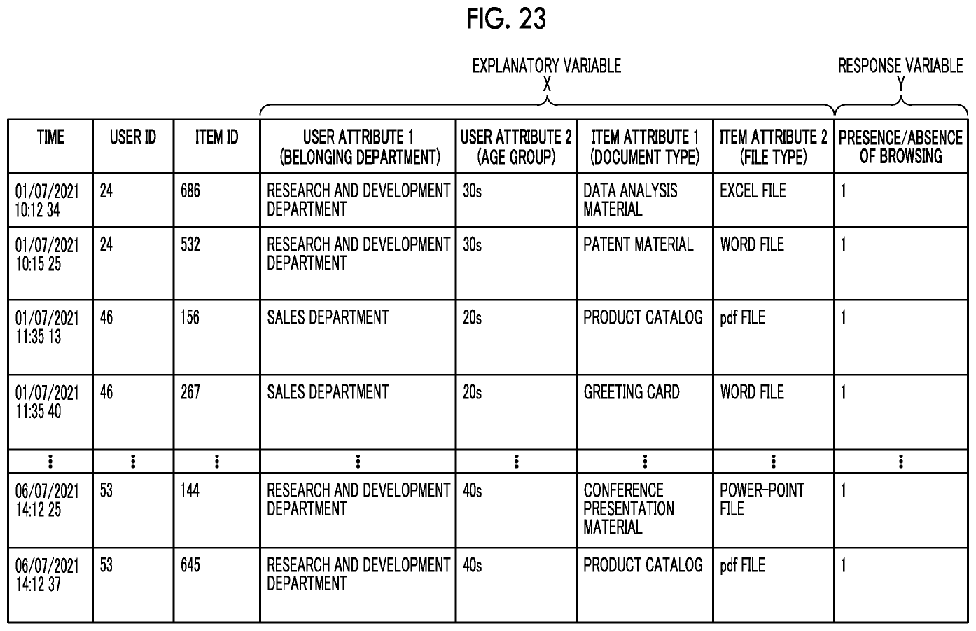

Here, it is considered the case of an in-house document suggestion system for a company. It is assumed that there is behavior history (here, document browse history) data of each of a company 1, a company 2, and a company 3 as data for a training and an evaluation. FIG. 23 is an example of behavior history data of a user on an item in the company 1. The “item” here is a document. The table shown in FIG. 23 has columns of “time”, “user ID”, “item ID”, “user attribute 1”, “user attribute 2”, “item attribute 1”, “item attribute 2”, and “presence/absence of browsing”.

The “time” is the date and time when the item is browsed. The “user ID” is an identification code that specifies a user, and an identification (ID) that is unique to each user is defined. The item ID is an identification code that specifies an item, and an ID that is unique to each item is defined. The “user attribute 1” is, for example, a belonging department of a user. The “user attribute 2” is, for example, an age group of a user. The “item attribute 1” is, for example, a document type as a classification category of items. The “item attribute 2” is, for example, a file type of an item. A value of “presence/absence of browsing” in a case of being browsed (presence of browsing) is “1”. Since the number of items that are not browsed is enormous, it is common to record only the browsed item (presence/absence of browsing=1) in the record.

The “presence/absence of browsing” in FIG. 23 is an example of the response variable Y, and each of the “user attribute 1”, “user attribute 2”, “item attribute 1”, and “item attribute 2” is an example of the explanatory variable X. The number of types of the explanatory variables X and the combination thereof are not limited to the example of FIG. 23. The explanatory variable X may further include a context 1, a context 2, a user attribute 3, an item attribute 3, and the like (not shown).

There are similar behavior history data for each of the company 2 and the company 3. It is assumed that the data of each company cannot be taken out. In this case, first, a local prediction model (local model) is trained for each company. A logistic regression model is used in which a user attribute 1 (belonging department), a user attribute 2 (age group), an item attribute 1 (document type), and an item attribute 2 (file type) are used as feature amounts and cross feature amounts are also used.

For the training, SGD is used, and updating is performed a designated number of times at a designated learning rate. As a result of the training, the weight of each feature amount is obtained for each individual local models LMk.

Next, each local model LMk is transferred to the global server GSV. At this time, the data used for the training is not transferred.

In the global server GSV, for each weight of the local model LM1 of the company 1, a difference between each weight of the local model LM2 of the company 2 and an average of each weight of the local model LM3 of the company 3 is taken. The global server GSV provides an instruction of subtracting a value obtained by multiplying this difference by a constant value from the local model LM1 of the company 1. Alternatively, the subtracted parameter is returned to the local model LM1 of the company 1. The same operation is performed on the local model LM2 of the company 2 and the local model LM3 of the company 3.

The steps of local model learning and parameter correction described above are repeated until the difference between the prediction error and the weight converges. As a result, the prediction model based on universal characteristics rather than characteristics unique to each company is built.

For example, in a case where a document browsing rate is higher as the age group is higher in the company 1, but the tendency is not seen in the company 2 and the company 3, the weight of the prediction model is small because a relation between the age group and the browsing rate is not universal. That is, the weight of the company 1 with respect to the age group is reduced, and the weight is assigned to the feature amount having the universal characteristic accordingly. On the other hand, in a case where the tendency that the probability of browsing the product catalog is high in the sales department is common to the companies 1 to 3, the weight is retained because the local models LM1 to LM3 of the companies 1 to 3 all have a high weight on this cross feature amount.

Regarding Model Representation

The method of representing the simultaneous probability distribution of the explanatory variable X and the response variable Y is not particularly limited, and for example, Matrix Factorization, logistic regression, Naive Bayes, or the like can be applied. In the case of any prediction model, by performing calibration such that an output score is close to the probability P(Y|X), it can be used as a method of the simultaneous probability distribution representation. For example, a support vector machine (SVM), a gradient boosting decision tree (GDBT), and a neural network model having any architecture can also be used.

Application to Neighborhood-based Collaborative Filtering

As a method of predicting a behavior of a user on an item, a neighborhood-based collaborative filtering based on a relationship between users or between items may be applied. The collaborative filtering is a method using a correlation such that, for example, a person who browses an item A also browses an item B. In that case, the domain regularization or the feature amount selection is applied with respect to whether the correlation between the item A and the item B, such that a person who browses the item A also browses the item B, is universal across domains. That is, the restriction is made such that correlation coefficients become close to each other, and a relationship in which the correlation coefficients are significantly different is excluded from the feature amount of the prediction model.

Example of Neighborhood-Based Collaborative Filtering

In the case of the neighborhood-based collaborative filtering, a prediction value y of the probability that the user browses the item is represented by, for example, the following Equation (18).

y=Σs_ij_d1×r_uj (18)
r_uj in Equation (18) takes a value of “1” in a case where the user “u” interacts with the item “j” (here, browsed), and takes a value of “0” in a case where the user “u” does not interact with the item “j”.

s_ij_d1 is a correlation coefficient between the item “i” and the item “j” in the domain d1.

That is, “y”, which is a prediction of the probability that the user u browses the item “i”, becomes larger as the user “u” browses the item having a high correlation with the item “i” in the past.

s_ij_d1 can be obtained by using the following Equation (19), for example, in the calculation method using the Jaccard index.

(number of users who browsed both items i and j)/(number of users who browsed at least one of items i or j) (19)

Example of Feature Amount Selection in case of Neighborhood-based Collaborative Filtering

In a case where s_ij is significantly different between the domains, it is preferable to exclude the correlation between the items from the prediction equation (set s_ij to 0). For example, s_ij_d1, s_ij_d2, and s_ij_d3 are excluded from the prediction equation (that is, the value is set to 0) in a case where the value of the following Equation (20) is equal to or greater than a constant value, and are not excluded in a case where the value is less than a constant value (these correlation coefficients are used as they are.).

|s_ij_d1−s_ij_d2|+|s_ij_d2−s_ij_d3|+|s_ij_d3−s_ij_d1| (20)

Regarding Program that Operates Computer

It is possible to record a program, which causes a computer to realize some or all of the processing functions of the information processing apparatus 100 and the global server GSV, in a computer-readable medium, which is an optical disk, a magnetic disk, or a non-temporary information storage medium that is a semiconductor memory or other tangible object, and provide the program through this information storage medium.

Further, instead of storing and providing the program in a non-transitory computer-readable medium such as a tangible object, it is also possible to provide a program signal as a download service by using an electric communication line such as the Internet.

Further, some or all of the processing functions in the information processing apparatus 100 and the global server GSV may be realized by cloud computing or may be provided as a software as a service (SaaS).

Regarding Hardware Configuration of Each Processing Unit

The hardware structure of a processing unit that executes various processes such as the parameter calculation unit 62, communication unit 64, the data acquisition unit 220, the local learning unit 230, the sampling unit 232, the feature amount selection unit 233, the loss calculation unit 234, the parameter update amount calculation unit 237, and the parameter update unit 238 in the information processing apparatus 100, and the communication unit 72, the difference between models-evaluation unit 74, the parameter calculation unit 75, the domain regularization calculation unit 76, the parameter difference-by-feature amount calculation unit 77, the learning correction unit 78, the feature amount selection unit 79, and the global model generation unit 80 in the global server GSV is, for example, various processors as shown below.

Various processors include a CPU, which is a general-purpose processor that executes a program and functions as various processing units, GPU, a programmable logic device (PLD), which is a processor whose circuit configuration is able to be changed after manufacturing such as a field programmable gate array (FPGA), a dedicated electric circuit, which is a processor having a circuit configuration specially designed to execute specific processing such as an application specific integrated circuit (ASIC), and the like.

One processing unit may be composed of one of these various processors or may be composed of two or more processors of the same type or different types. For example, one processing unit may be configured with a plurality of FPGAs, a combination of CPU and FPGA, or a combination of CPU and GPU. Further, a plurality of processing units may be composed of one processor. As an example of configuring a plurality of processing units with one processor, first, as represented by a computer such as a client or a server, there is a form in which one processor is configured by a combination of one or more CPUs and software, and this processor functions as a plurality of processing units. Second, as represented by a system on chip (SoC) or the like, there is a form in which a processor, which implements the functions of the entire system including a plurality of processing units with one integrated circuit (IC) chip, is used. In this way, the various processing units are configured by using one or more of the above-mentioned various processors as a hardware-like structure.

Further, the hardware-like structure of these various processors is, more specifically, an electric circuit (circuitry) in which circuit elements such as semiconductor elements are combined.

### Advantages of Embodiment

According to the above-described embodiment, even in a case where data of a plurality of facilities cannot be shared outside the facility, it is possible to train a model having robust performance against differences in facilities. According to the present embodiment, in the case of a training of a model, even in a case where the data of each facility cannot be taken out of the facility, it is possible to generate a universal model that does not depend on a characteristic of a facility, and it is possible to realize the provision of a suggestion item list that is robust against the domain shift.

### Modification Example of Embodiment

In the above-described embodiment, although an example of federated learning is described, the present disclosed technology, which provides a model with domain generalization by performing a training with a constraint condition such that a difference between models of a plurality of local models LMk is small, is not limited to the federated learning. For example, in a case where it is possible to share data of a plurality of facilities, or in a case where data can be taken out, a system including one or more computers may perform a training of a local model LMk for each facility by using data of each of the plurality of facilities and may generate a model with domain generalization by controlling each of the trainings such that the difference between the models is small.

### Other Application Examples

In FIG. 23, browsing of a document in a company has been described as an example, but the scope of application of the present disclosure is not limited to this example. For example, the present disclosed technology can be applied to models that predict user behavior regarding various items, regardless of the application, such as browsing of medical images and various documents at medical facilities such as hospitals, purchasing behavior of users at retail stores, or viewing content such as videos on content providing sites, or the like.

### Others

The present disclosure is not limited to the above-described embodiment, and various modifications can be made without departing from the spirit of the idea of the present disclosed technology.

### EXPLANATION OF REFERENCES

10: suggestion system
12: prediction model
14: model
50: machine learning system
52: electric communication line
62: parameter calculation unit
64: communication unit
72: communication unit
74: difference between models-evaluation unit
75: parameter calculation unit
76: domain regularization calculation unit
77: parameter difference-by-feature amount calculation unit
78: learning correction unit
79: feature amount selection unit
80: global model generation unit
100: information processing apparatus
102: processor
104: computer-readable medium
106: communication interface
108: input/output interface
110: bus
112: memory
114: storage
130: local learning program
136: local data storage unit
152: input device
154: display device
220: data acquisition unit
222: data storing unit
230: local learning unit
230B: local learning unit
232: sampling unit
233: feature amount selection unit
234: loss calculation unit
236: optimizer
237: parameter update amount calculation unit
238: parameter update unit
250: data output unit
302: processor
304: computer-readable medium
306: communication interface
308: input/output interface
310: bus
312: memory
314: storage
330: difference between models-evaluation program
332: learning control program
334: global model generation program
352: input device
354: display device
420: data acquisition unit
422: data storing unit
430: global learning unit
430B: global learning unit
450: data output unit
IT1: item
IT2: item
IT3: item
M1: model
M2: model
Mn: model
LD1, LD2, LD3, LDk, LDn: local data
LM1, LM2, LM3, LMk, LMn: local model
LT1, LT2, LT3, LTk, LTn: local learning apparatus
S10 to S18: steps of machine learning method

What is claimed is:

1. A machine learning method executed by an information processing system including one or more processors, the machine learning method comprising:
causing the information processing system to execute:
performing a training, by using data of each facility collected at each of a plurality of facilities, of a local model that predicts, for each of the facilities, a behavior of a user on an item;
performing an evaluation of a difference between models in a parameter of the local model trained for each of the facilities; and
correcting the training of the local model such that the difference between the models is small based on a result of the evaluation.

2. The machine learning method according to claim 1,
wherein the correcting of the training of the local model includes changing the parameter such that the difference between the models is small.

3. The machine learning method according to claim 2,
wherein the local model includes a cross feature amount, and
the machine learning method further comprises causing the information processing system to execute changing the parameter such that the difference between the models in the parameter, which is a weight of the cross feature amount, is small in the case of correcting the training of the local model.

4. The machine learning method according to claim 1,
wherein the correcting of the training of the local model includes changing the local model by, from among a plurality of feature amounts included in the local model, selecting a feature amount, in which the difference between the models in the parameter is relatively small, and by deleting a feature amount, in which the difference between the models in the parameter is relatively large, from the local model.

5. The machine learning method according to claim 4,
wherein the local model includes a cross feature amount, and
the machine learning method further comprises causing the information processing system to execute: from among the plurality of feature amounts including the cross feature amount, selecting a cross feature amount, in which the difference between the models in the parameter that is a weight of the cross feature amount is relatively small; and deleting a cross feature amount, in which the difference between the models in the parameter is relatively large, in the case of correcting the training of the local model.

6. The machine learning method according to claim 3,
wherein the weight of the cross feature amount is represented in a relation between embedding representations of each of the feature amounts.

7. The machine learning method according to claim 6,
wherein the relation between the embedding representations of each of the feature amounts is an inner product of vectors indicating each of the feature amounts.

8. The machine learning method according to claim 1,
wherein the local model is a model that performs a neighborhood-based collaborative filtering, which is based on at least one of relationships between users or between items, and the parameter of the local model includes a correlation coefficient that indicates at least one of the relationships between the users or between the items.

9. The machine learning method according to claim 8, further comprising:
causing the information processing system to execute changing the correlation coefficient such that a difference in the correlation coefficient between the models is made to be small in the case of correcting the training of the local model.

10. The machine learning method according to claim 8, further comprising:
causing the information processing system to execute: from among a plurality of the relationships included in the local model, selecting a relationship, in which a difference in the correlation coefficient between the models is relatively small; and deleting a relationship, in which the difference in the correlation coefficient between models is relatively large, from the local model, in the case of correcting the training of the local model.

11. The machine learning method according to claim 1,
wherein the information processing system includes
a plurality of information processing apparatuses, which execute the training of the local model, corresponding to each of the plurality of facilities, and
a server that is connected to each of the plurality of information processing apparatuses via an electric communication line in a communicable manner, and
the training is performed by using federated learning for communicating at least one of the parameter of the local model or an update amount of the parameter between the information processing apparatus and the server without communicating the data of each facility.

12. The machine learning method according to claim 11,
wherein the server
acquires the parameter of the local model from each of the plurality of information processing apparatuses,
performs an evaluation of the difference between the models in the parameter of the local model, and
performs an instruction of correcting the training with respect to each of the plurality of information processing apparatuses, and
each of the plurality of information processing apparatuses performs at least one of changing the parameter of the local model or selecting a feature amount, based on the instruction.

13. The machine learning method according to claim 11,
wherein the local model is a model that performs a neighborhood-based collaborative filtering, which is based on at least one of relationships between users or between items, and the parameter of the local model includes a correlation coefficient that indicates at least one of the relationships between the users or between the items.

14. An information processing system comprising:
one or more processors,
wherein the one or more processors are configured to:
perform a training, by using data of each facility collected at each of a plurality of facilities, of a local model that predicts, for each of the facilities, a behavior of a user on an item;
perform an evaluation of a difference between models in a parameter of the local model trained for each of the facilities; and
correct the training of the local model such that the difference between the models is small based on a result of the evaluation.

15. The information processing system according to claim 14, further comprising:
a plurality of information processing apparatuses, which execute the training of the local model, corresponding to each of the plurality of facilities; and
a server that is connected to each of the plurality of information processing apparatuses via an electric communication line in a communicable manner,
wherein the training is performed by using federated learning for communicating at least one of the parameter of the local model or an update amount of the parameter between the plurality of information processing apparatuses and the server without communicating the data of each facility.

16. An information processing apparatus comprising:
one or more first processors; and
one or more first storage devices,
wherein the one or more first processors are configured to:
perform a training, by using first data collected at a first facility, of a first local model that predicts a behavior of a user on an item in the first facility;
transmit a parameter of the first local model, on which the training is performed, to a server;
receive, from the server, an instruction of correcting the training of the first local model such that a difference between models in a parameter of a second local model trained by using second data that is collected at a second facility different from the first facility, is smaller; and
update the first local model based on the received instruction.

17. A server comprising:
one or more second processors; and
one or more second storage devices,
wherein the one or more second processors are configured to:
acquire a parameter of a local model trained at each of a plurality of information processing apparatuses corresponding to each of a plurality of facilities;
perform an evaluation of a difference between models in the parameter of the local model for each of the facilities; and
transmit an instruction of correcting a training of the local model such that the difference between the models is small with respect to each of the plurality of information processing apparatuses, based on a result of the evaluation.

18. A non-transitory, computer-readable tangible recording medium which records thereon a program for causing, when read by a computer, the computer to realize:
a function of performing a training, by using data of each facility collected at each of a plurality of facilities, of a local model that predicts, for each of the facilities, a behavior of a user on an item;
a function of performing an evaluation of a difference between models in a parameter of the local model trained for each of the facilities; and
a function of correcting the training of the local model such that the difference between the models is small based on a result of the evaluation.

19. A non-transitory, computer-readable tangible recording medium which records thereon a program for causing, when read by a computer, the computer to realize:
a function of performing a training, by using first data collected at a first facility, of a first local model that predicts a behavior of a user on an item in the first facility;
a function of transmitting a parameter of the first local model, on which the training is performed, to a server;
a function of receiving, from the server, an instruction of correcting the training of the first local model such that a difference between models in a parameter of a second local model trained by using second data that is collected at a second facility different from the first facility, is smaller; and
a function of updating the first local model based on the received instruction.

20. A non-transitory, computer-readable tangible recording medium which records thereon a program for causing, when read by a computer, the computer to realize:
a function of acquiring a parameter of a local model trained at each of a plurality of information processing apparatuses corresponding to each of a plurality of facilities;
a function of performing an evaluation of a difference between models in the parameter of the local model for each of the facilities; and
a function of transmitting an instruction of correcting a training of the local model such that the difference between the models is small with respect to each of the plurality of information processing apparatuses, based on a result of the evaluation.
